(19) United States
(12) Patent Application Publication
(10) Pub. No.: US 2016/0281417 A1
(43) Pub. Date: Sep. 29, 2016

(54) A DRAINAGE UNIT

(71) Applicant: LATERAL DESIGN STUDIOS LIMITED, London, Greater London (GB)

(72) Inventor: William John Harte, London (GB)

(21) Appl. No.: 15/032,757

(22) PCT Filed: Oct. 28, 2014
(86) PCT No.: PCT/GB2014/053203

§ 371 Date: Apr. 28, 2016

(30) Foreign Application Priority Data
Oct. 28, 2013 (GB) 1318985.7
Mar. 26, 2014 (GB) 1405426.6

(51) Int. Cl. E06B 7/14; E06B 1/70; E03F 1/00

(52) U.S. Cl. CPC E06B 7/14; E03F 1/00; E06B 1/70

(57) ABSTRACT

A drainage unit comprises a first drainage trough and a second drainage trough; said second drainage trough being located adjacent to said first drainage trough; said first drainage trough being configured to attach to a drain cover in order to allow fluid to flow into the first trough; said second trough comprising at least a wall which projects laterally from said first trough; said wall being suitable for accommodating a sub-floor level rail or frame of a door; a number of openings located between said first and second drainage troughs; whereby fluid flows from said second trough into said first trough through said openings. In preferred embodiments, the drainage unit provides an integral level door threshold solution.

### FIELD OF THE INVENTION

The invention relates generally to drains and has particular application in the field of channelling fluid away from a structure such as a doorway. Embodiments of the invention have particular application where level access is required for collecting driven rainfall that enters the door frame/section and exits via the side or bottom of the door frame/threshold section. Embodiments of the invention also provide means for collecting surface water from surrounding areas.

### BACKGROUND TO THE INVENTION

The prior art known to the applicant is their own drainage apparatus which concerns a drain for draining water away from a doorway. The drain comprises a drainage channel, positioned at sub-ground level, spaced apart from a doorway. A waterproof membrane is placed immediately adjacent to the doorway. The drain also incorporates a drain cover which has apertures to allow fluid to flow into the top of the drain.

This apparatus of the prior art is unreliable as drainage of fluid from the bottom of the doorway to the drainage channel relies on correct positioning of the waterproof membrane. Due to the detailing of the existing structure, the channel is spaced apart from the doorway. As it has to be done accurately, setting up this apparatus can be time consuming and complex because if the waterproof membrane is not positioned suitably and due to likely membrane failure, fluid may not flow into the drainage channel effectively. Maintenance and repair of this apparatus can also be required if the membrane's position changes or if the membrane is damaged or degraded.

The door threshold section is totally independent from the channel drain or trench drain. Prior art channels are also generally made of plastic or poly concrete such as those destined to be employed in driveways. In other words, they are not suitable for appropriate operation in a position adjacent to the threshold of a door.

The following prior art documents are acknowledged: JPH11310945, JP2000328799, JP2000096858, JPH10102928 AND JPH04360982.

### SUMMARY OF THE INVENTION

In a first broad independent aspect, the invention provides a drainage unit comprising a first drainage trough and a second drainage trough; said second drainage trough being located adjacent to said first drainage trough; said first drainage trough being configured to attach to a drain cover in order to allow fluid to flow into the first trough; said second trough comprising at least a wall which projects laterally from said first trough; said wall being suitable for accommodating a sub-floor level rail or frame of a door; a number of openings located between said first and second drainage troughs; whereby fluid flows from said second trough into said first trough through said openings. This configuration may be particularly advantageous when applied any of the following non-limiting list: ground floor, basement well areas and balcony constructions.

The configuration of the invention provides a drainage unit which is positioned underneath and immediately adjacent to the frame of a door by providing a level door access solution. Openings between the first and second drainage troughs allow the captured water to flow from the second trough to the first trough and away from the doorframe. The laterally projecting wall of the second trough is suitable for accommodating a sub-floor level rail or frame of a door. This ensures effective capture of all fluid that flows to the bottom of the door.

The unit requires simple deployment as it does not require as careful positioning of multiple components which are often incompatible. The laterally projecting wall of the second drainage trough is positioned underneath a doorframe and any collected fluid will flow into the first drainage trough and away from the doorframe. This configuration potentially ensures a bespoke installation in certain embodiments.

Preferably, the wall's configuration is adjustable dependent on the configuration of the sub-floor level rail or frame of a door which said drainage unit accommodates.

This configuration provides the advantage of allowing captured water to flow from the second trough to the first trough and away from the doorframe. The laterally projecting wall of the second trough is suitable for accommodating sub-floor level rails or frames of doors which vary in size. This ensures effective capture of all fluid that flows to the bottom of a door irrespective of its configuration.

This configuration ensures a bespoke installation even where the configuration of a sub-floor level rail or door frame is of an unusual shape or size.

Preferably, said second trough comprises a bottom surface; and at least a portion of said bottom surface of said second drainage trough closest to said first trough slopes downwards towards said openings. This configuration provides the advantage of facilitating movement of collected fluid away from the doorframe into the first drainage trough. By sloping, the bottom surface of the second drainage trough does not allow any fluid to accumulate underneath the doorframe or collect in unwanted areas. It allows an effective water seal to be formed between threshold and extended drain trough.

Preferably, the first drainage trough incorporates a bottom wall and two side walls; and said second drainage trough incorporates a bottom wall; said bottom wall of said first trough being located lower than the bottom wall of said second trough. This configuration further ensures that fluid collected from the doorframe naturally flows towards the first drainage trough and away from the doorframe.

Preferably, the top of each side wall of said first trough incorporates an L-shaped ledge. This configuration allows a drain cover to be removably placed on the first drainage trough. The surface area of the ledge will also help to secure the drainage unit at a sub-ground level position.

Preferably, said first drainage trough and said second drainage trough are integrally formed. This configuration minimises the opportunity for fluid to collect in unwanted areas and the pathway for fluid to flow from the doorframe to the first drainage trough is consistent. This configuration also provides a resilient structure and simplifies deployment of the unit as only one component is installed. Installation is therefore more accurate. The requirement for maintenance and repair is also reduced.

Preferably, the first and second troughs may be supplied as a one piece for installation or in two sections for ease of installation, fixed on site by one or more fasteners to a predetermined location and water proof seals.

Preferably, the unit is an integrated threshold and channel drain.

Preferably, said drainage unit comprises a sub-floor level rail or frame of a door being attached to said second trough. This configuration provides the advantage of securely positioning the drainage unit giving a level door access with a drainage channel. As the laterally projecting wall of the second drainage trough is suitable to accommodate a sub-floor level rail or frame, the unit is prevented from moving in relation to that rail or frame. It also increases the efficiency of the unit to collect all fluid which flows down to the rail or frame as the unit will not move.

Preferably, said second trough comprises a bottom wall and a side wall; and wherein said drainage unit further comprises a fastener for securing a sub-floor level rail or frame of a door to said bottom wall or said side wall of said second trough. This configuration further secures the drainage unit to the sub-floor level rail or frame, so that as the door is opened, closed or moved in any other way, the drainage unit does not become dislodged from its effective position.

Preferably, said drainage unit comprises a clipping mechanism between said bottom wall of said second trough and said sub-floor level rail or frame. This configuration provides the advantage of securing the drainage unit to the sub-ground level rail or frame of the doorway.

In a further independent aspect, the invention provides a drainage unit comprising a trough; and clipping means for securing said unit to the door or part of the door/threshold of a door.

Preferably, said drainage unit comprises a clip for securing said second trough to a face of a door threshold. Preferably, this connection forms a connecting seal between frame and drain trough.

Preferably, said first and second drainage troughs are substantially U-shaped. This configuration ensures that any collected fluid drains to the bottom of the second drainage trough and subsequently into the first drainage trough and away from the doorframe.

Preferably, each side wall of said first drainage trough incorporates a number of apertures at each extremity. This configuration provides a means for attaching multiple lengths of the drainage unit together in order to cover a large area. This is especially advantageous where a number of doors are positioned adjacent to each other and a number of drainage units are required. Preferably, the first and second troughs have all associated channel components that allow the line of the drain to follow the line of the building with reveals, end-caps, outlets, spigots in order to provide a completely integrated system.

Preferably, said unit incorporates a joining member which is fixable between said apertures of two adjacent drainage units. This configuration ensures that two or more drainage units are effectively connected to allow fluid to flow along the first drainage troughs of adjacent units and into a larger drain system.

Preferably, said joining member is substantially U-shaped and sized and shaped to fit within said first trough. This configuration provides a joining member which effectively joins two lengths of drainage unit together in watertight connection. By being U-shaped sized and shaped to fit within the first trough, the joining member prevents any fluid loss from the first or second trough once the fluid has drained away from the doorframe.

Preferably, the underside of both adjacent troughs is covered with a waterproof membrane. This configuration further improves the efficiency of the drainage unit. The waterproof membrane prevents any fluid from draining into any unwanted areas surrounding the drainage unit and forces the liquid into the second and subsequently first drainage troughs.

Preferably, said first trough is vertically adjustable in relation to said second trough. This configuration provides the advantage of accommodating a sub-floor level rail or frame of a door especially where the rail or frame is located a particularly deep level underground. The first trough can therefore be vertically adjusted so that it is positioned at an appropriate ground level.

Preferably, said at least a wall of said second trough is laterally extendible. This configuration provides the advantage of accommodating a sub-floor level rail or frame of a door especially where the rail or frame extends particularly far from the first trough. The configuration of the bracket allows the unit to be extended to accommodate the rail or frame.

Preferably, said unit incorporates a fastener for securing said first trough to said at least a wall of said second trough. This configuration ensures that there is a watertight configuration between the first trough and the wall to efficiently drain fluid away from a door.

Preferably, said at least a wall of said second trough incorporates a stepped portion. This configuration prevents drained fluid from re-entering the sub-floor level rail or door frame.

Preferably, said unit incorporates an infill positioned between said first trough and said sub-floor level rail or frame of a door which said unit accommodates. This configuration provides the advantage of sealing a gap that may be present between a sub-floor level rail or frame of a door and the first trough.

Preferably, said unit comprises a fastening mechanism between said bottom wall of said second trough and a membrane extending from said sub-floor level rail or frame. This configuration is particularly advantageous because it allows the drainage unit to be retrofitted to a pre-existing sub-ground level rail or frame of a doorway. The laterally extending bottom wall of the second trough can be fastened to a membrane which extends from the pre-existing rail or frame, thus creating a pathway to the first trough and away from the doorway.

Preferably, said unit comprises a fastening mechanism between said bottom wall of said second trough and a part of said sub-floor level rail or frame of a door. This configuration is particularly advantageous because it provides a means for employing the drainage unit where a sub-ground level rail or frame has a pre-existing fluid deflector.

In a further broad aspect, the invention provides a drainage unit comprising a first drainage trough and a wall which projects laterally from said first drainage trough; said first drainage trough being configured to attach to a drain cover in order to allow fluid to flow into the first trough; a number of openings located between said first drainage trough and said wall; whereby fluid flows from said wall into said first trough through said openings.

### BRIEF DESCRIPTION OF THE FIGURES

FIG. 1 shows a perspective view of a preferred embodiment of the drainage unit.

FIG. 2 shows a cross sectional view of the preferred embodiment of FIG. 1.

FIG. 3 shows a cross sectional view of an alternative embodiment of the invention.

FIG. 4 shows a cross sectional view of another alternative embodiment of the invention.

FIG. 5 shows a cross sectional view of another alternative embodiment of the invention.

FIG. 6 shows a cross sectional view of another alternative embodiment of the invention.

FIG. 7 shows a cross sectional view of another alternative embodiment of the invention.

FIG. 8 shows a cross sectional view of another alternative embodiment of the invention.

FIG. 9 shows a cross sectional view of another alternative embodiment of the invention.

FIG. 10 shows a cross sectional view of another alternative embodiment of the invention.

FIG. 11 shows a cross sectional view of another alternative embodiment of the invention.

FIG. 12 shows a cross sectional view of another alternative embodiment of the invention.

FIG. 13 shows a cross sectional view of another alternative embodiment of the invention.

FIG. 14 shows a perspective view of a preferred embodiment of the drainage unit.

FIG. 15 shows a cross sectional view of the preferred embodiment of FIG. 14.

FIG. 16 shows a cross sectional view of an alternative embodiment of the invention.

FIG. 17 shows a cross sectional view of another alternative embodiment of the invention.

FIG. 18 shows a cross sectional view of yet another alternative embodiment of the invention.

FIG. 19 shows a cross sectional view of the wall and adjustable plate of the second trough.

FIG. 20 shows an exploded view of a preferred embodiment of the invention.

FIG. 21 shows a cross sectional view of an alternative embodiment of the invention where the drainage unit is retrofitted to an existing sub-ground level rail or frame of a doorway.

FIG. 22 shows a cross sectional view of another alternative embodiment of the invention where the drainage unit is retrofitted.

FIG. 23 shows a cross sectional view of yet another alternative embodiment of the invention where the drainage unit is retrofitted.

FIG. 24 shows a cross sectional view of another alternative embodiment of the invention.

FIG. 25A shows a cross sectional view of a part of an alternative embodiment of the invention.

FIG. 25B shows a front view of a part of an alternative embodiment of the invention.

FIG. 25C shows a front view of another part of an alternative embodiment of the invention.

FIG. 26 shows plan views of parts of an alternative embodiment of the invention.

FIG. 27 shows cross sectional views of parts of an alternative embodiment of the invention.

FIG. 28 shows a perspective view of an alternative embodiment of the invention.

FIG. 29 shows a perspective view of another alternative embodiment of the invention.

FIG. 30 shows a perspective view of yet another alternative embodiment of the invention.

FIG. 31A shows a perspective view of part of another alternative embodiment of the invention.

FIG. 31B shows a cross sectional view of yet another alternative embodiment of the invention.

FIG. 32 shows a perspective view of yet another alternative embodiment of the invention.

FIG. 33 shows an exploded perspective view of an alternative embodiment of the invention.

FIG. 34 shows an exploded perspective view of another alternative embodiment of the invention.

FIG. 35 shows a perspective view of parts of an alternative embodiment of the invention.

### DETAILED DESCRIPTION OF THE FIGURES

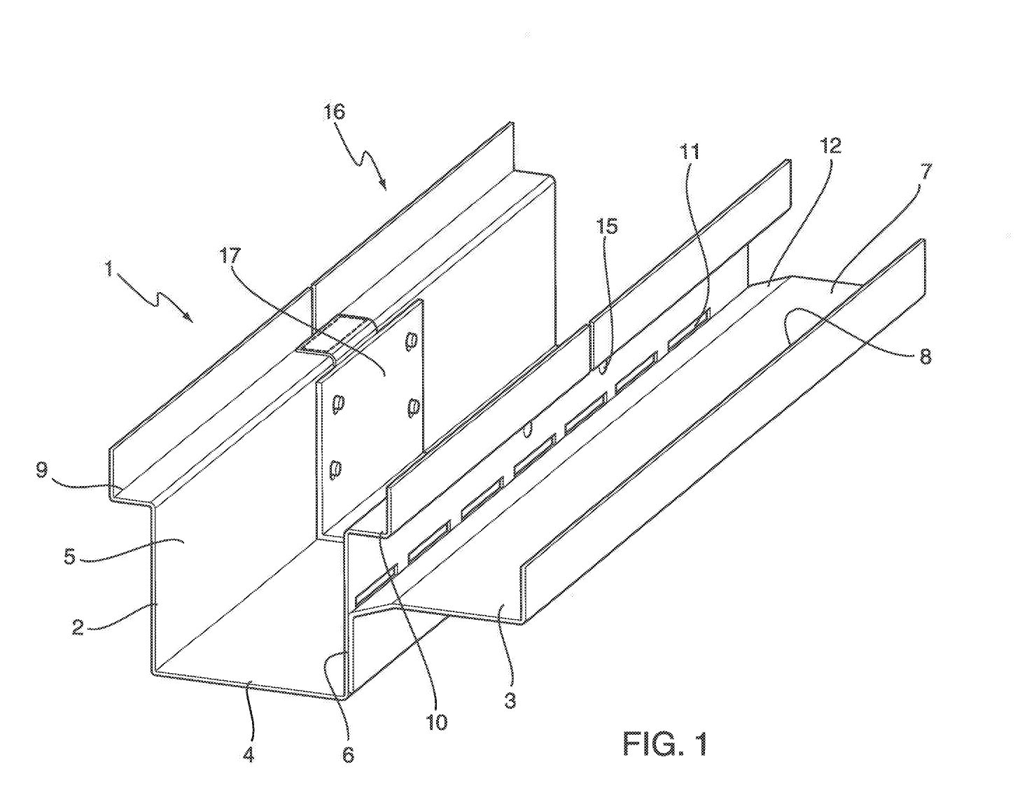

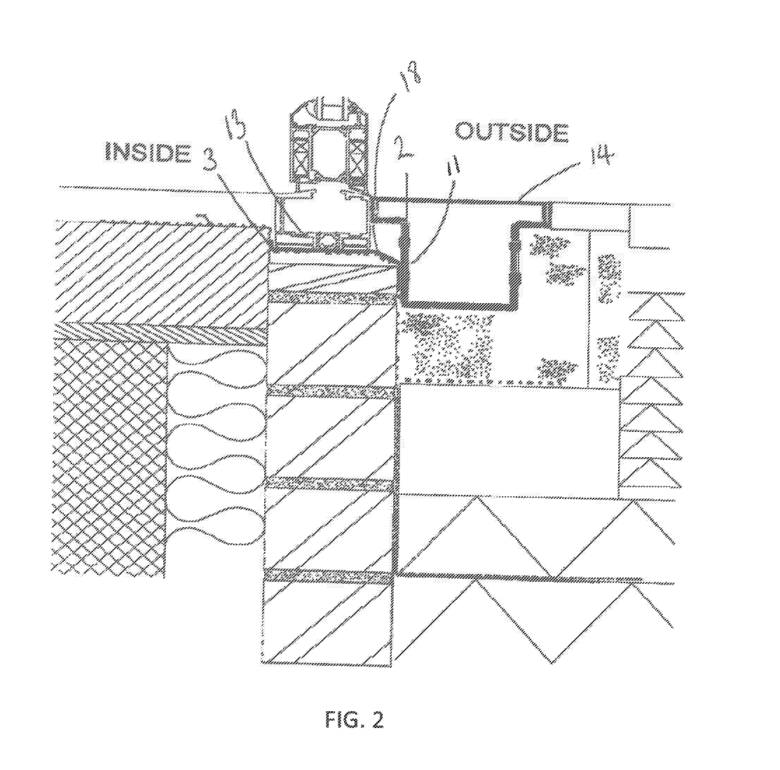

A preferred embodiment of the drainage unit 1 of the current invention is first illustrated in FIG. 1. The current invention comprises first 2 and second 3 drainage troughs which are integrally formed, the second drainage trough 3 being suitable to accommodate a sub-floor level rail or frame of a door (not shown), and the first drainage trough 2 being positioned adjacent to the second drainage trough 3. The first drainage trough 2 is substantially U-shaped, having a bottom wall 4 and two side walls 5 and 6. The second drainage trough is also substantially U-shaped, having a bottom wall 7 and a side wall 8, the bottom wall 7 joining the side wall 6 of the first trough 2. In use, fluid will drain down a door when it rains, when the door is being washed, when condensation accumulates, or in other circumstances. When the fluid reaches the bottom of the door and flows into the sub-ground level rail or frame of the doorway, it is collected in the second drainage trough 3 which surrounds the sub-ground level rail or frame 13 (shown in FIG. 2).

A number of openings such as 11 are positioned between the first 2 and second 3 drainage troughs. In a preferred embodiment these openings are arranged laterally across the side wall 6, in line with the bottom wall 7 of the second trough 3. In use, the openings facilitate movement of fluid collected in the second drainage trough 3 into the first drainage trough 2 and away from the doorway. Once the fluid has drained into the first drainage trough 2, it will drain into a larger conventional drainage system (not shown). In one embodiment, to facilitate movement of fluid into a larger drainage system from the first drainage trough 2, the drainage unit 1 is sloped downwards towards a central drain. In this embodiment, the drainage unit 1 incorporates an end cap (not shown) at its raised end, and an end cap incorporating a drainage spout (not shown) at its lowered end.

In a preferred embodiment, at least a portion 12 of the bottom wall 7 of the second drainage trough 3 slopes downwards towards the openings 11 to further facilitate the movement of liquid into the first drainage trough 2 and to prevent any collected liquid from collecting in unwanted areas underneath the doorframe. The angle of the sloped portion 12 is preferably between 5 and 85 degrees and is even more preferably between 25 and 60 degrees. The portion 12 of the bottom wall 7 of the second drainage trough 3 may, in an alternative embodiment, have a stepped configuration down towards the openings 11.

In an even further preferred embodiment, to further facilitate movement of fluid from a doorframe into the first drainage trough 2, the bottom wall 4 of the first drainage trough 2 is situated lower than the bottom wall 7 of the second drainage trough 3. This configuration ensures that collected fluid naturally flows into the first drainage trough 2.

In a preferred embodiment, the first drainage trough 2 incorporates an L-shaped ledge at the top of each side wall 9 and 10. Each L-shaped ledge aids the stability of the drainage unit 1 at sub-ground level. The ledges also act as a support for a drain cover 14 which is placed on top of the drainage unit (see FIGS. 2 to 5). In a preferred embodiment, the drain cover incorporates a number of openings (not shown) to create a 2-point fluid entry system where fluid can run from ground level straight into the first drainage trough 2 as well as from the doorway, into the second drainage trough 3 and subsequently into the first trough 2.

The preferred embodiment is particularly advantageous when employed for level or rebated doorways, offering unhindered access across the doorway. This is especially advantageous where level access is required for a wheelchair, pushchair or similar, as the wheelchair or pushchair does not need to be lifted over the threshold of the doorway.

Illustrated in FIG. 2, the drainage unit 1 is located under a sub-ground level rail or frame for a door 13. The sub-ground level rail or frame 13 is accommodated in the second drainage trough 3. In an even further preferred embodiment, the drainage unit 1 is attached to the rail or frame 13 using a number of fasteners (not shown) selected from a range known to the skilled person, for example riv nuts, bolts or staples. This configuration ensures that all liquid that drains down the side of the door will be collected in the second drainage trough 3 and will subsequently flow into the first drainage trough 2 and away from the doorway.

In one embodiment, shown in FIG. 1, the side walls 5 and 6 of the first drainage trough 2 incorporate a number of apertures such as 15 at their extremities in order to provide means for attaching more than one drainage units together. In a preferred embodiment, a second drainage unit 16 is joined to the first drainage unit 1 using a joining member 17. The joining member is preferably substantially U-shaped and sized and shaped to fit within the first and second drainage units, 1 and 16, to ensure that the joined drainage units are watertight and effectively drain fluid away from the doorway into a larger drainage system. This is especially advantageous where a number of doors are positioned adjacent to each other and a number of drainage units are required.

To further ensure that the drainage unit (or multiple adjacent drainage units) is watertight, the underside of the first and second drainage troughs, 2 and 3, is covered with a waterproof membrane 18. This also further ensures that no fluid will collected in unwanted areas as the hydrophobic nature of the membrane will encourage fluid to drain away from the doorway and into the first drainage trough.

In one embodiment, the drainage unit is positioned on a supporting bed, which consists of a material such as concrete, at sub-ground level. The unit is subsequently supported by materials such as pea single at its sides in order to maintain the drainage unit 1 at an effective position.

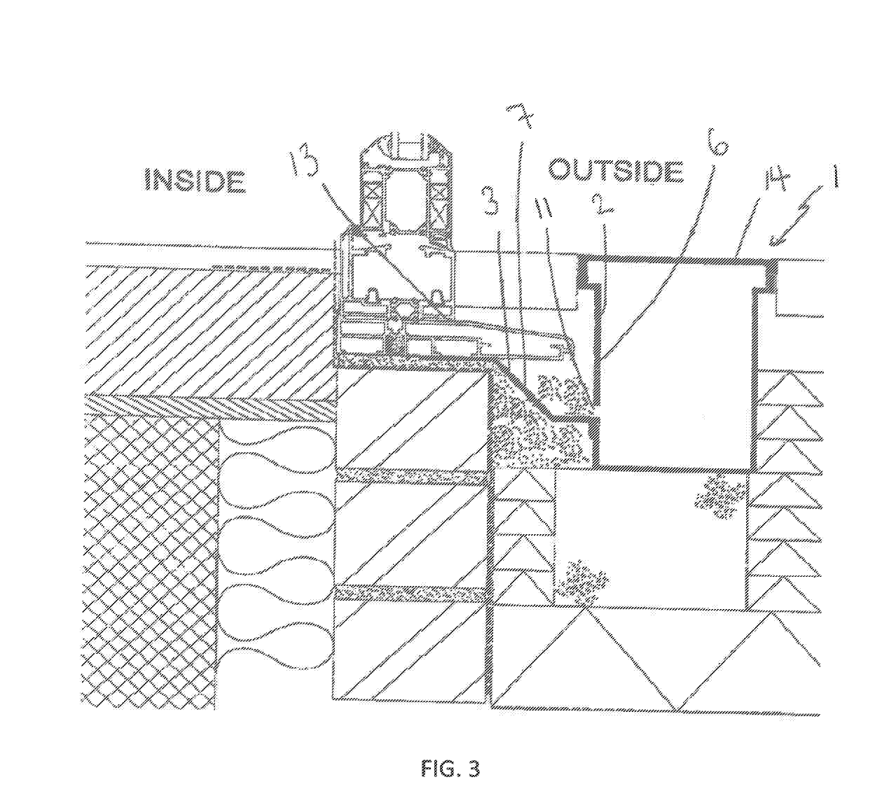

FIG. 3 shows an alternative embodiment of the invention where the second trough 3 of the drainage unit 1 comprises a bottom wall 7 which is positioned underneath the sub-ground level rail or frame of the doorway 13. The bottom wall 7 is shaped so as to lead captured fluid away from the doorway into the first trough 2, through openings 11. The bottom wall 7 has a flat configuration underneath the sub-ground level rail or frame of the doorway and subsequently slopes downwards towards the first trough 2. The angle of the slope is preferably between 5 and 85 degrees and is even more preferably between 25 and 60 degrees. The bottom wall 7 has a flat configuration where it laterally projects from the side wall 6 of the first trough 2. Openings 11 where the bottom wall 7 laterally projects from the side wall 6 of the first trough 2 allow collected fluid to flow into the first trough 2. The configuration of the embodiment shown in FIG. 3 is particularly suitable where the sub-ground level rail or frame of the doorway extends towards the first trough 2. When this occurs, the first trough can be placed further away from the doorway but the laterally projecting wall 7 of the second trough 3 can extend beneath the extension of the rail or frame to collect fluid that has drained from the doorway. This is also advantageous where, for drainage or aesthetic reasons, the drain cover 14 is required to be placed at a distance from the doorway. The bottom wall 7 laterally projects adjacent to or beneath the rail or frame of the doorway whilst an infill, such as 53, is employed at ground level between the first trough 2 and the doorway.

In one embodiment, the drainage unit comprises a clipping mechanism between the laterally projecting bottom wall 7 of the second trough 3 and the sub-ground level rail or frame of the doorway. This configuration provides a secure connection between the rail or frame and the drainage unit so that the two do not become disengaged and therefore ineffective. This also allows the unit to be retrofitted if doors/frames have already been installed.

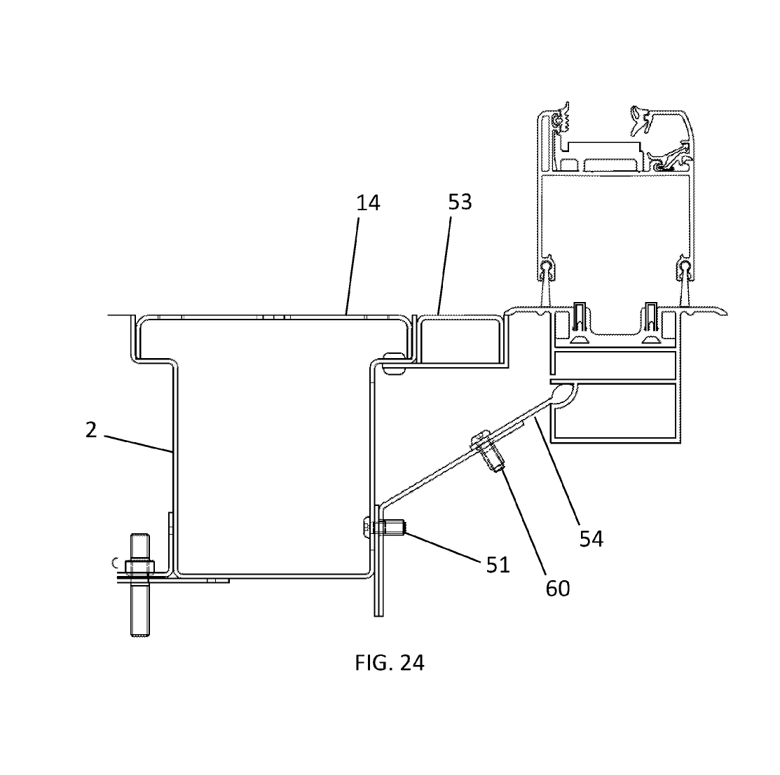

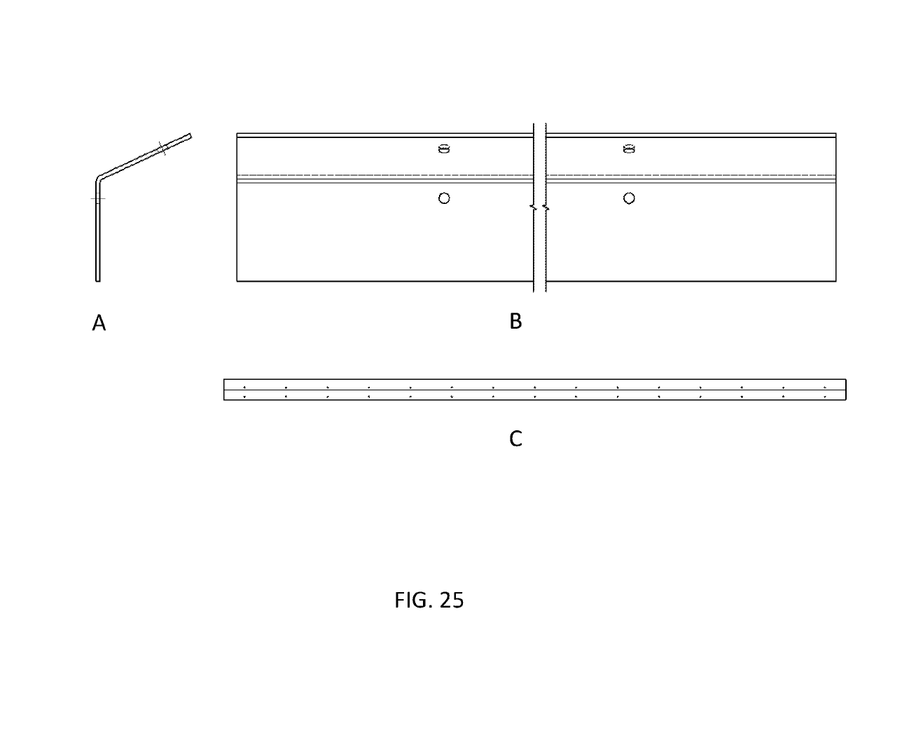

In another alternative embodiment, the drainage unit comprises a clipping mechanism between the laterally projecting bottom wall 7 of the second trough 3 and a pre-existing deflector plate 54 of the sub-ground level rail or frame of the doorway. Such an alternative embodiment is shown in FIG. 24, where the projecting bottom wall 7 and pre-existing deflector plate 54 form a junction. The wall 7 and deflector plate 54 are attached via a fastening 60, such as a riv nut. FIGS. 25A to 25C show an example of a pre-existing deflector plate which the laterally projecting wall 7 would be attached to in such an alternative embodiment.

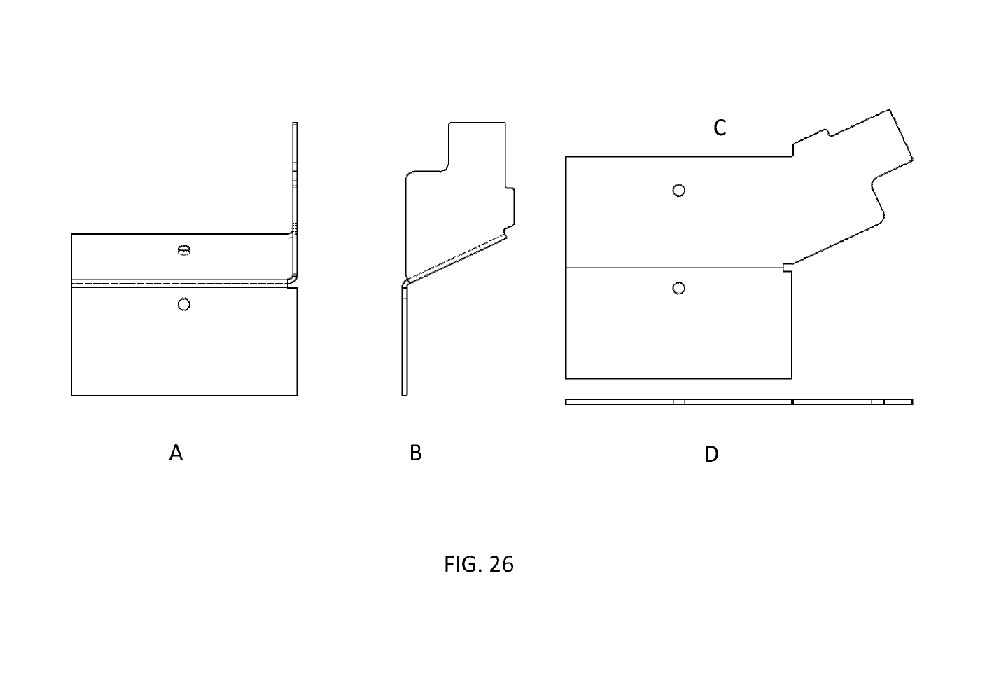

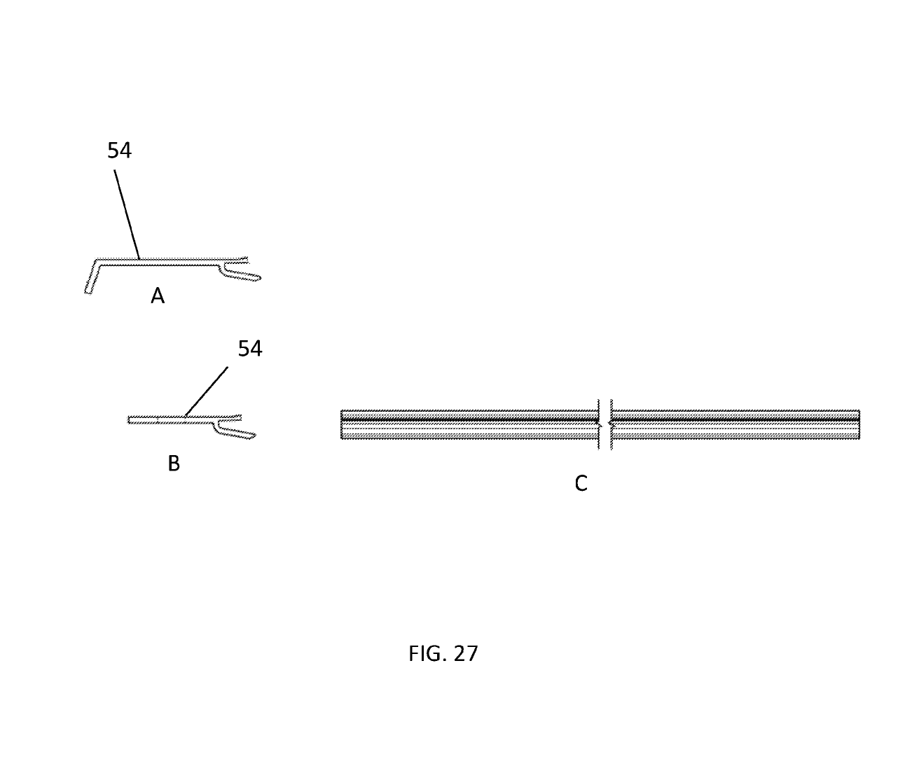

In order to attach the wall 7 to a pre-existing deflector plate 54, the deflector plate 54 may in some instances require adapting. Shown in FIGS. 27A and 27B, a pre-existing deflector plate 54 (27A) is modified (27B) in order that it can be brought into contact and fixed to the laterally projecting bottom wall 7 of the second trough 3. Modification of the deflector plate 54 may include shortening the deflector plate 54 and cutting at least one aperture into the deflector plate 54 (shown in FIG. 27C) to allow a fastener to pass through the deflector plate 54 and the laterally projecting bottom wall 7.

Where the laterally projecting wall 7 is to be attached to a deflector plate of a sub-ground level rail or frame, stop ends are provided to be attached to the ends of the attached deflector plate and wall 7. Such stop ends are shown in FIGS. 26A to 26D. Preferably, the stop ends are provided in a flat configuration and are folded once a pre-existing deflector plate and the laterally projecting wall 7 have been attached, such that the stop ends can precisely fit on the end of the deflector plate and wall 7.

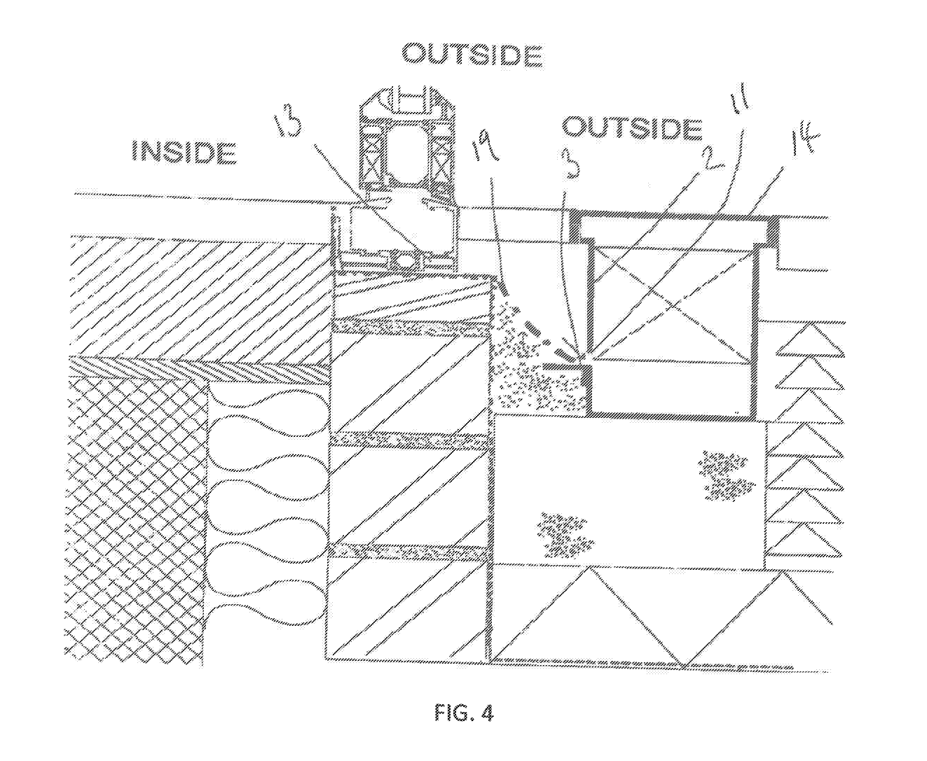

FIG. 4 shows another alternative embodiment of the invention where the laterally projecting wall of the second trough 3 does not project underneath the sub-ground level rail or frame of a doorway 13, but extends adjacent to this structure. A membrane or mesh 19 extends from the sub-ground level rail or frame to the openings 11 of the first trough in order to allow fluid to flow from the doorway into the first trough 2. A membrane may also be applied to surface of external wall to prevent water from penetrating the structure.

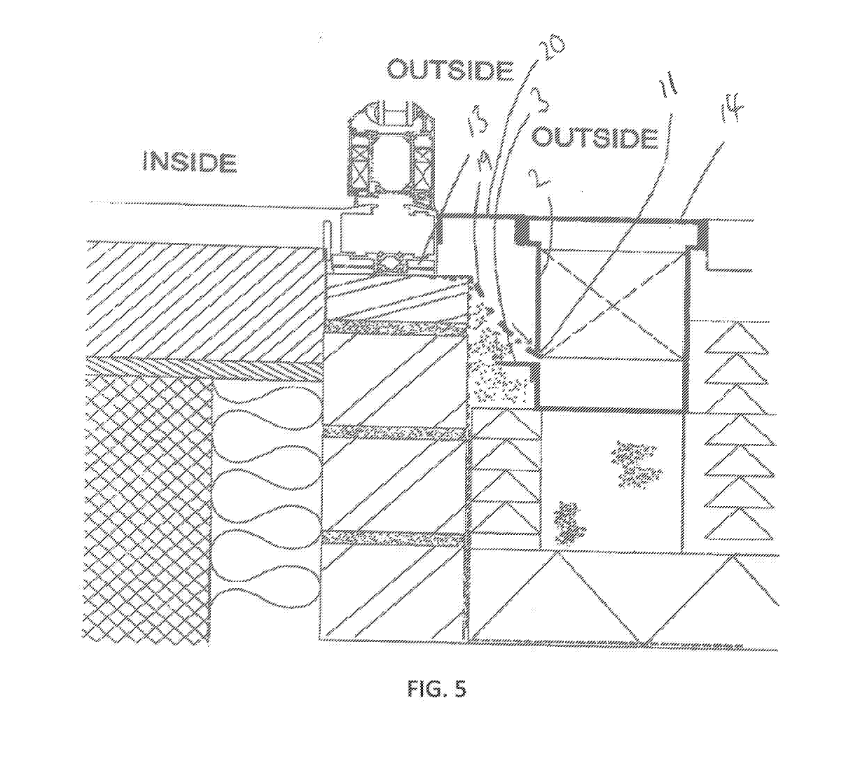

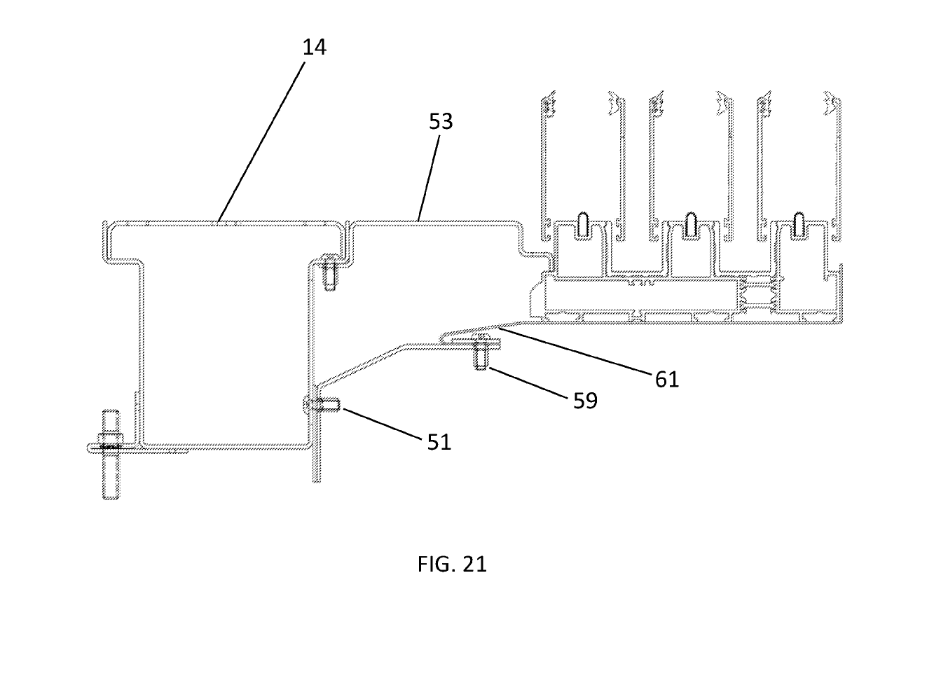

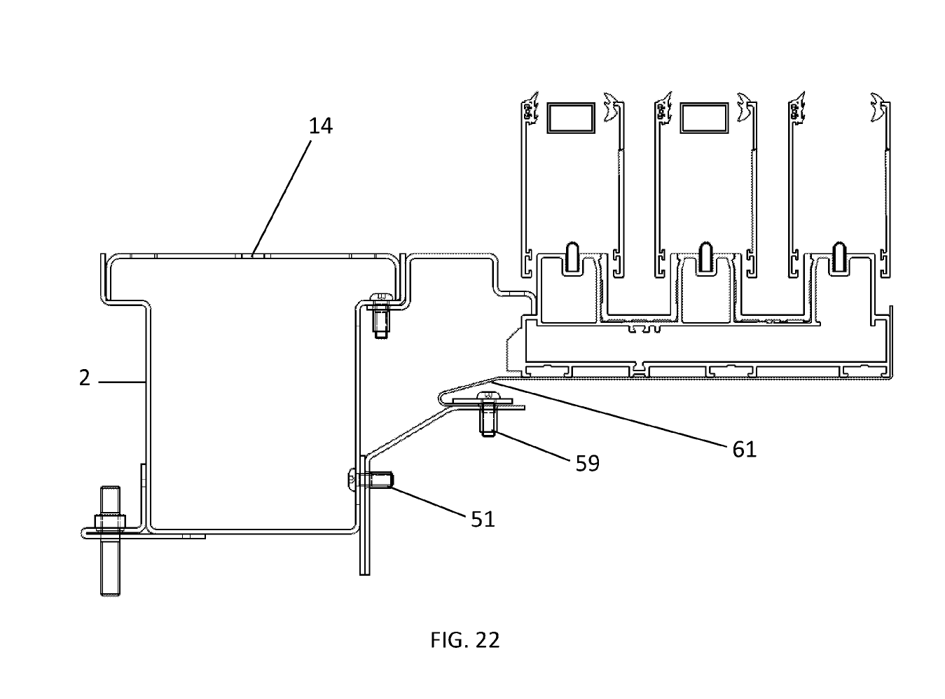

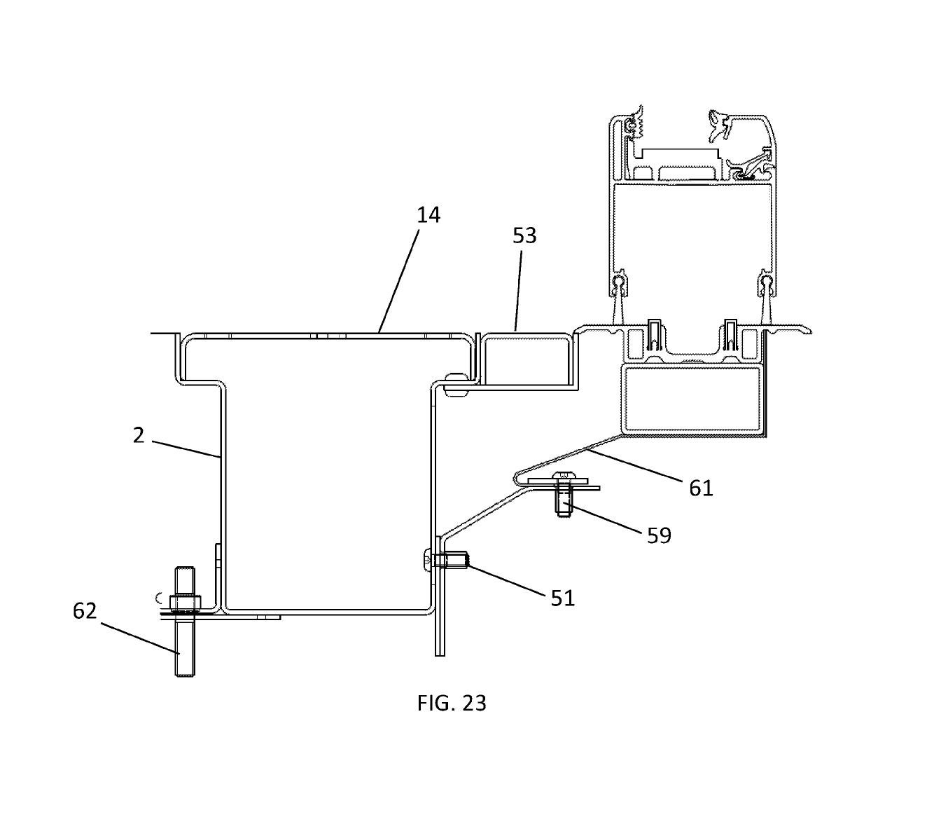

FIG. 5 shows yet another alternative embodiment of the invention where the laterally projecting wall of the second trough 3 does not project underneath the sub-ground level rail or frame of a doorway 13, but extends adjacent to this structure. A membrane or mesh 19 extends from the sub-ground level rail or frame to the openings 11 of the first trough in order to allow fluid to flow from the doorway into the first trough 2. In this embodiment, a second laterally projecting wall 20 extends from the top of the first trough to the top of the sub-ground level rail or frame 13 at ground level. The second laterally projecting wall 20 acts as a connecting cover for the sub-ground level components and ensures that the doorframe and the top of the first trough 2 are substantially level. Preferably, this configuration forms an integral drain unit providing a level access drain solution. Optionally, bottom surface 4 or base of drain may be laid to have a graded fall to increase water removal.

Where a pre-existing membrane 61, such as an ethylene propylene diene monomer rubber (EPDM) membrane, extends from the sub-ground level rail or frame towards the drainage unit 1, the laterally projecting wall 7 of the second trough 3 can be attached to the membrane. This is particularly advantageous where the drainage unit 1 is to be retrofitted to a pre-existing sub-ground level rail or frame of a doorway. In such alternative embodiments, which are shown in FIGS. 21 to 23, the EPDM 61 is fastened to the laterally projecting wall 7 of the second trough 3 using a fastener such as a riv nut 59. Preferably the EPDM 61 is folded back on itself prior to fastening to prevent the fastener 59 from coming into contact with drained fluid, thus improving the watertight capability of the drainage unit 1 whilst preventing the need to replace the fastener due to corrosion over time.

In these and other embodiments, a number of adjustable legs or anchors are provided, such as 62, to adjust the height of the drainage unit 1 and level and anchor the first trough 2 to a required level.

In a preferred embodiment the drainage unit 1 consists of a metal, such as aluminium. Even more preferably the aluminium has a powder coated finish. This minimises the possibility that the unit will break or deform under the pressure of the sub-ground level rail or frame when in position or when it is being deployed, or that it will degrade over time. However, in an alternative embodiment the drainage unit 1 consists of plastic, which is more straightforward to produce than metal and therefore the speed of production of drainage units is increased.

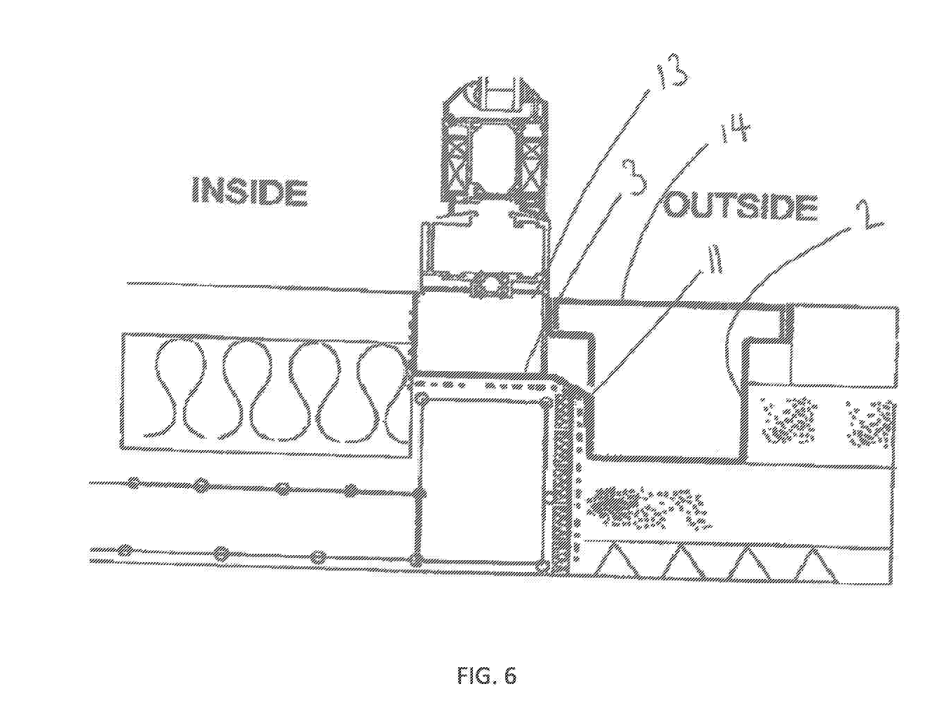

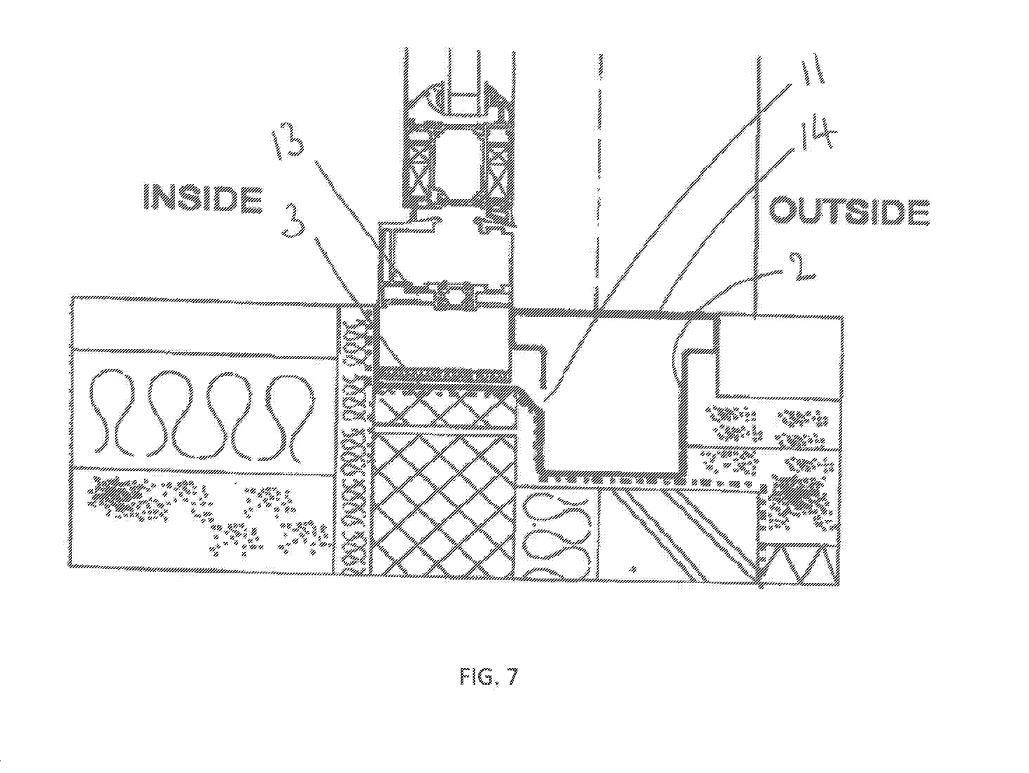

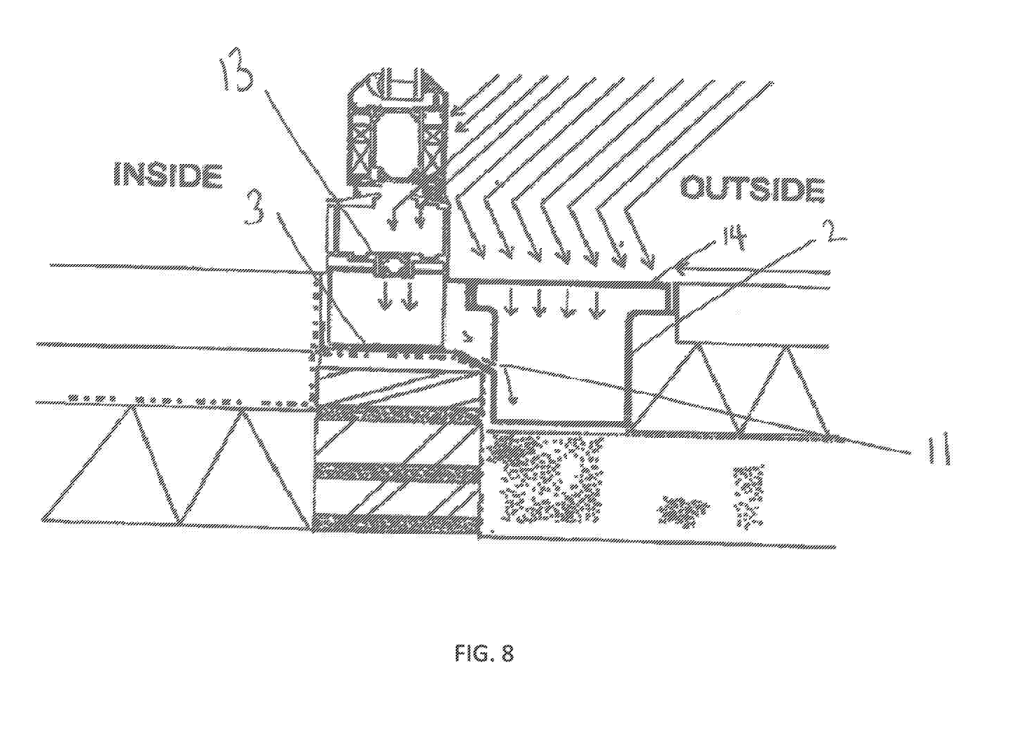

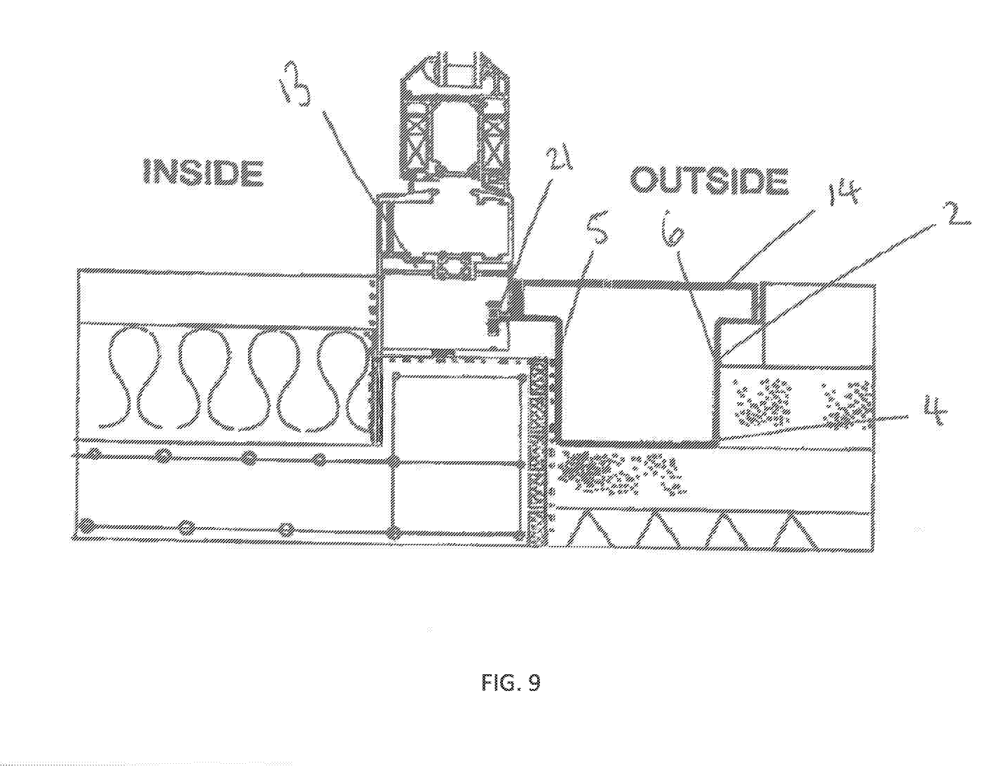

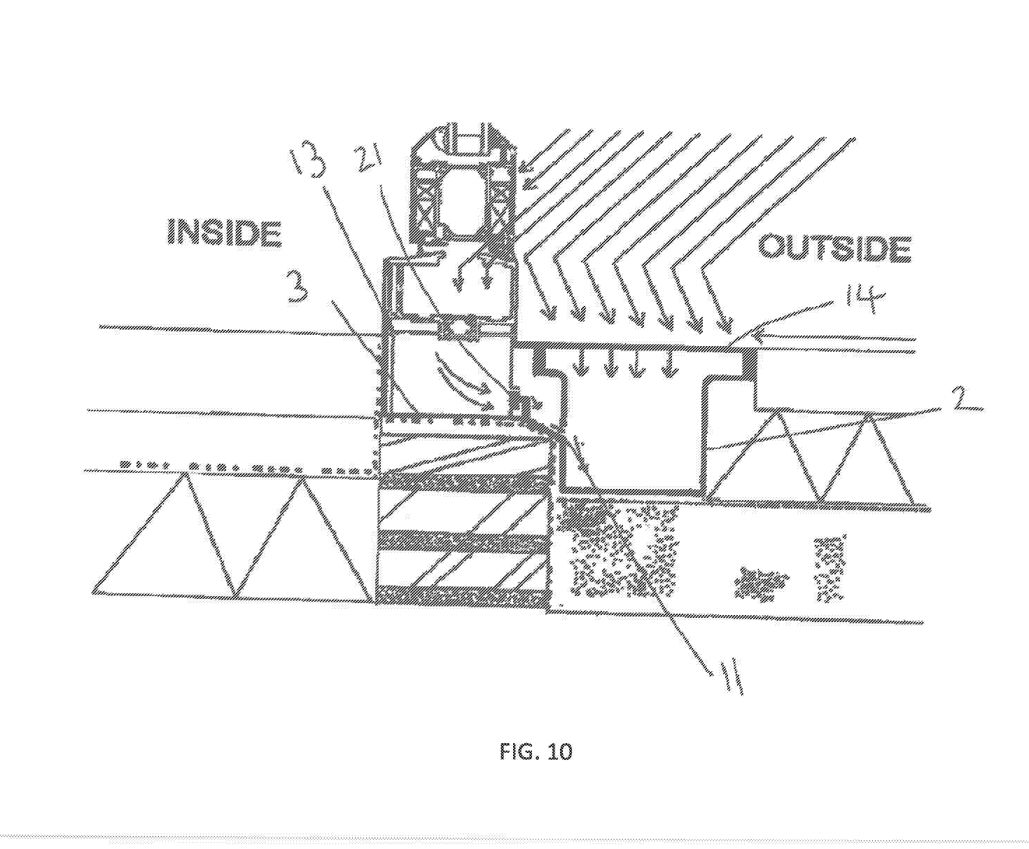

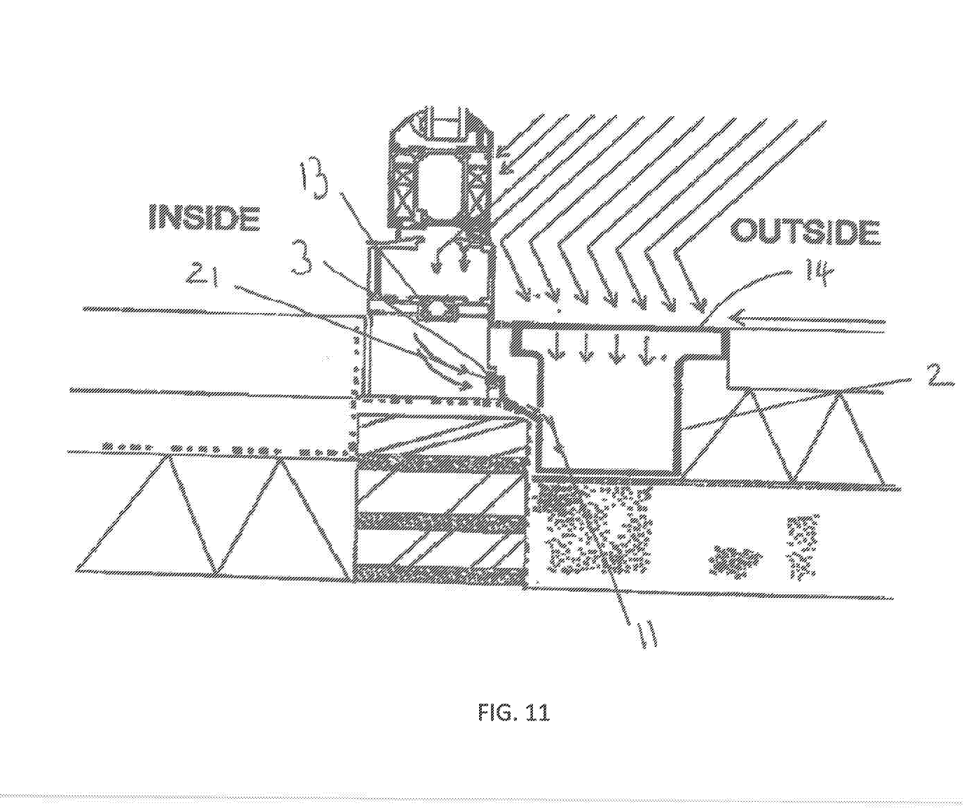

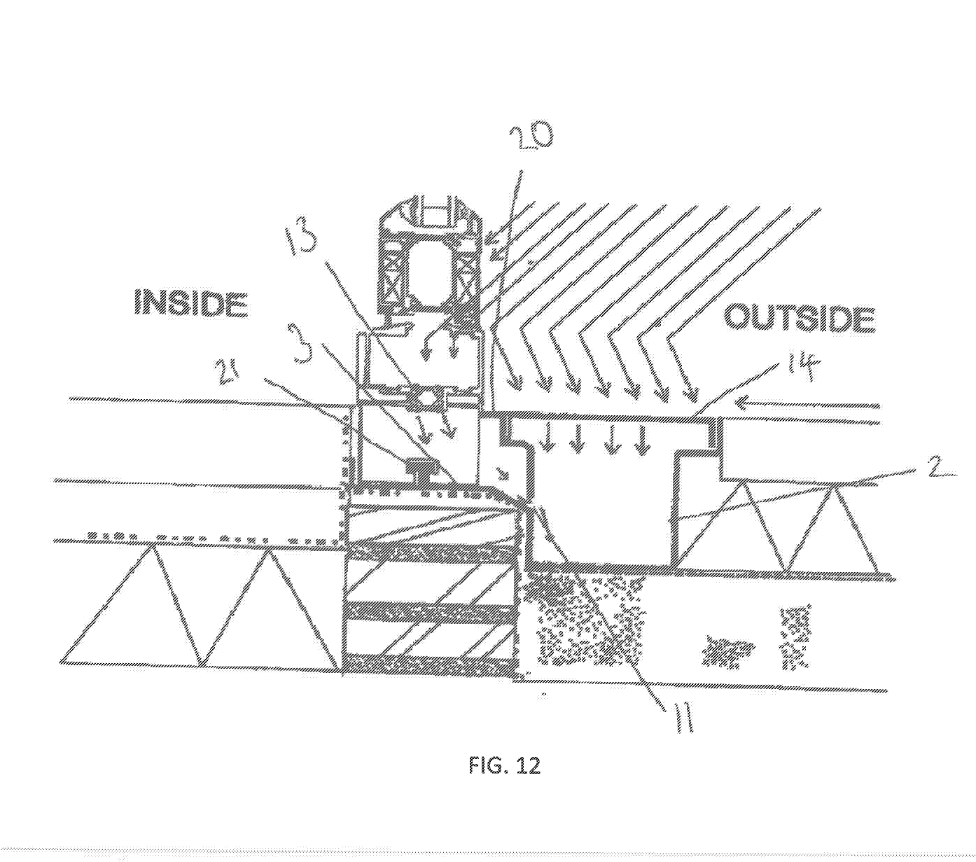

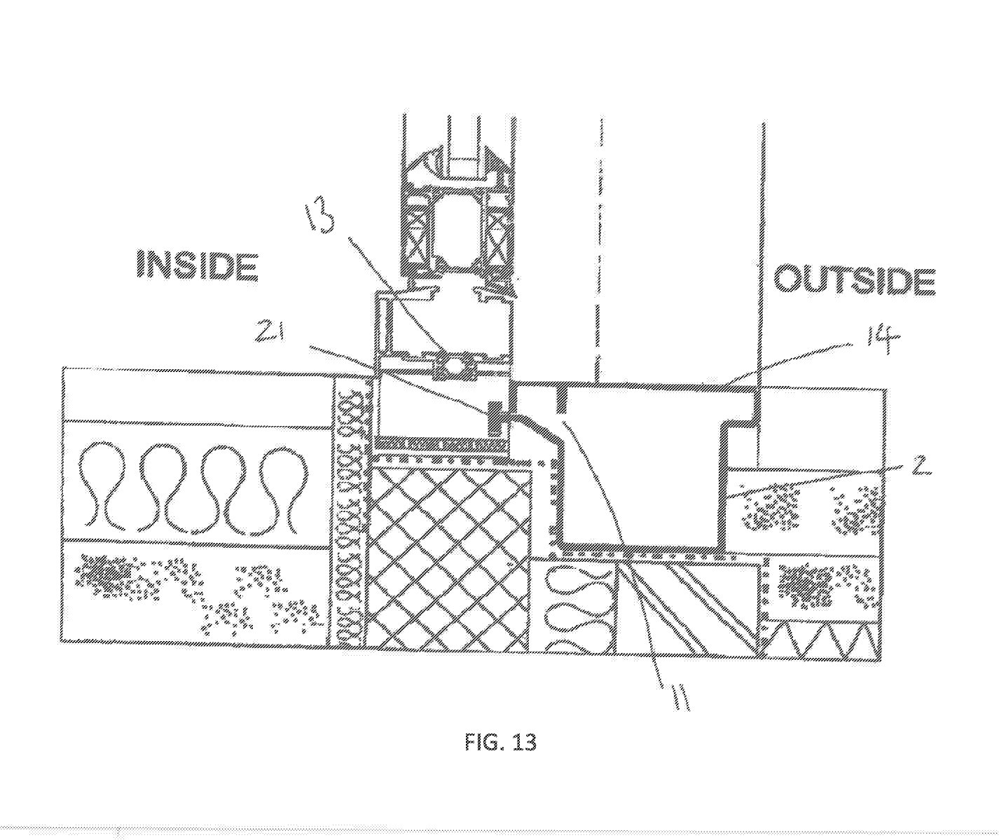

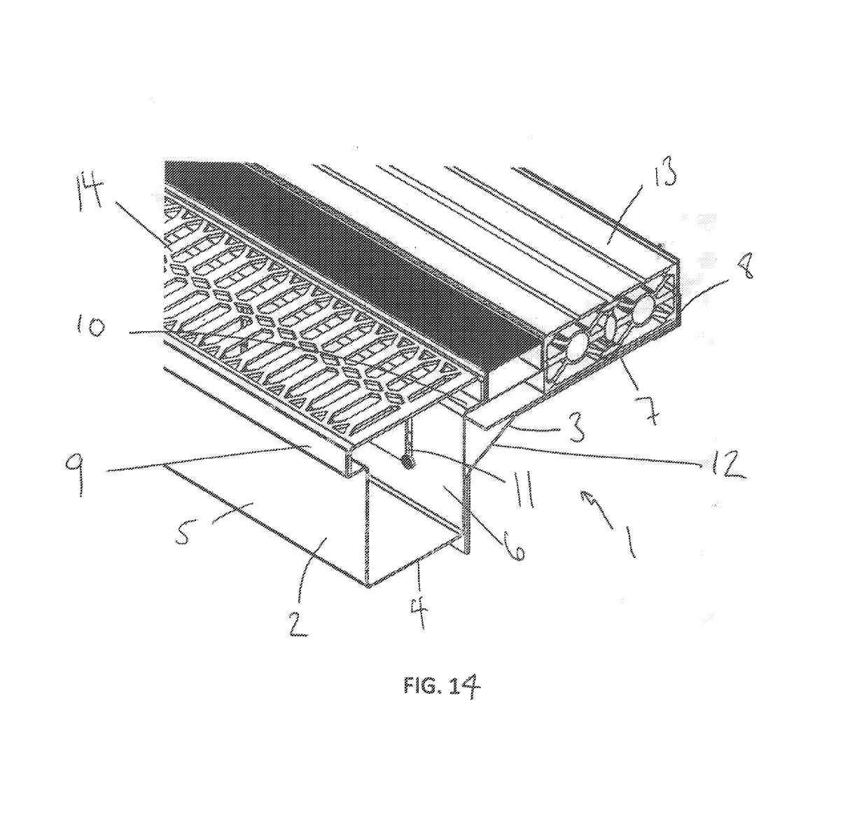

Installation of the drainage unit 1 at sub-ground level ensures that access through the doorway is not impaired. Preferably, this configuration provides a level door access solution. The configuration provides options to let the drainage unit sit within the brick reveal depth of the door opening so that the overall inside and outside surfaces are level. This is especially important where the doorway needs to be suitable for a wheelchair or for a person who requires easy access through a doorway without a raised step or the like. FIGS. 6, 7 and 8 show further alternative embodiments of the invention, where the second trough 3 accommodates a sub-floor level rail or frame of a door 13. FIGS. 9 to 13 show further alternative embodiments of the invention, where the drainage unit comprises a clipping mechanism 21 between the laterally projecting bottom wall 7 of the second trough 3 and the sub-ground level rail or frame of the doorway. This configuration provides a secure connection between the rail or frame and the drainage unit so that the two do not become disengaged and therefore ineffective. This also allows the unit to be retrofitted if doors/frames have already been installed.

In a number of alternative embodiments, the dimensions of the drainage troughs 2 and 3 can be altered to suit specific door frames and rails. The length, width depth and profile of either trough can be altered for all door systems.

In another alternative embodiment, a drain cover (not shown) consists of one of the following: stainless steel, cast iron, stone and resin or aluminium. In alternative embodiments using aluminium the aluminium can be mill finished, of anodized colours or of powder coated colours.

In further embodiments, the drainage unit may be adapted to be used in internal building wet and dry areas, swimming pools, spas, wet rooms, and bathrooms. The drainage unit can be applied to external and internal environments, such as orangeries, conservatories, beside swimming pools, and internally as lift drains.

In the preferred embodiment of the invention, the wall of the second trough 3 has a configuration which is adjustable dependent on the configuration of the sub-floor level rail or frame of a door which said drainage unit accommodates. This allows the drainage unit to fit sub-floor level rails or frames of doors with varying size and shape. This ensures that the unit is accurately utilised and fluid is effectively drained even where a rail/frame is of an unusual configuration.

In a preferred embodiment, the wall 7 incorporates an L-shaped bracket 50 which is laterally extendible in relation to said wall 7. In use, if a sub-floor level rail or frame of a door extends away from the first trough, the bracket 50 can be extended in order to accommodate the rail/frame.

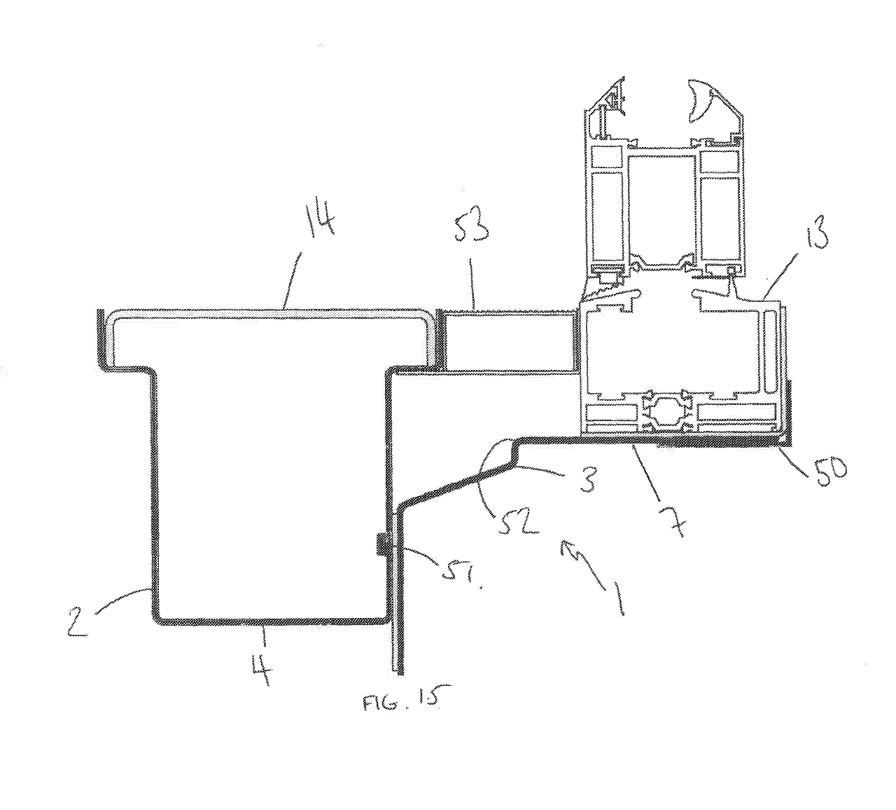

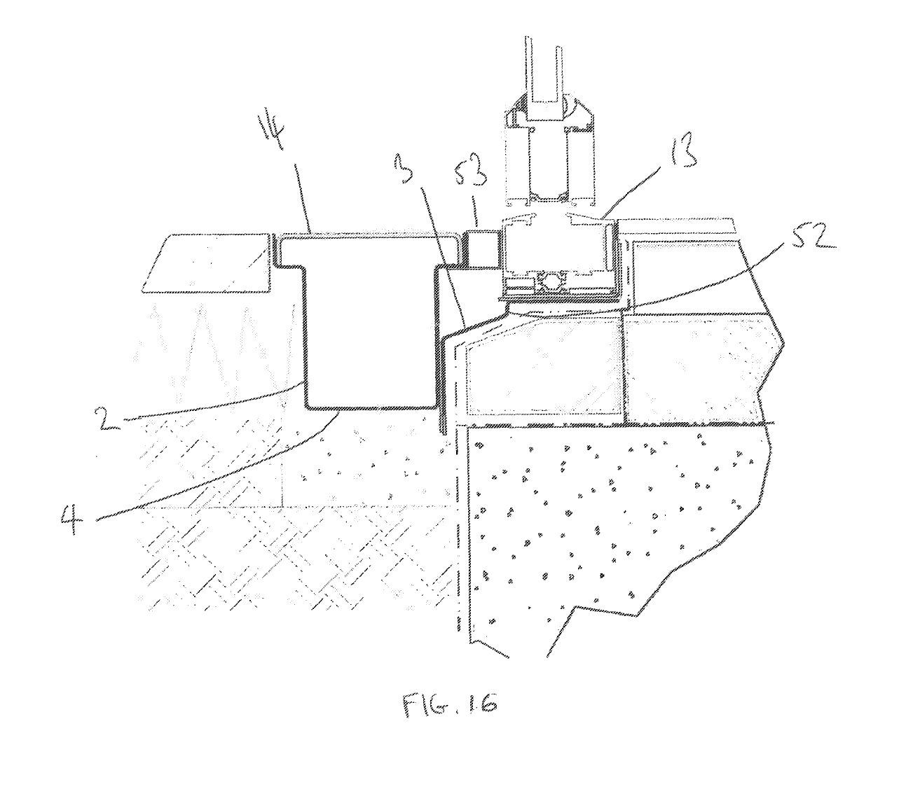

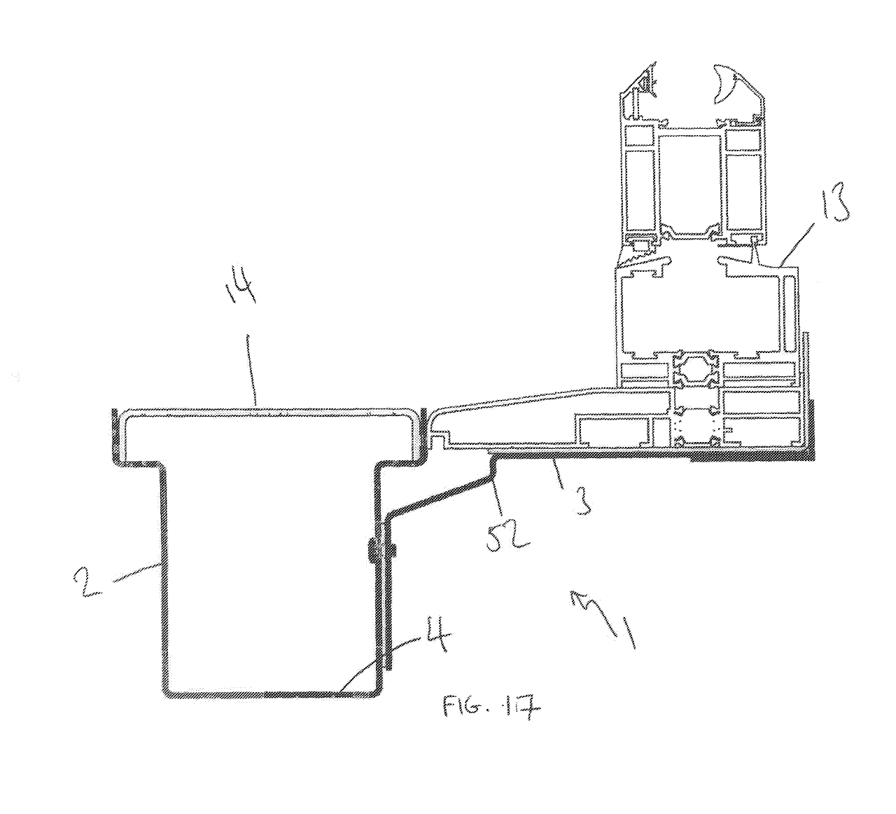

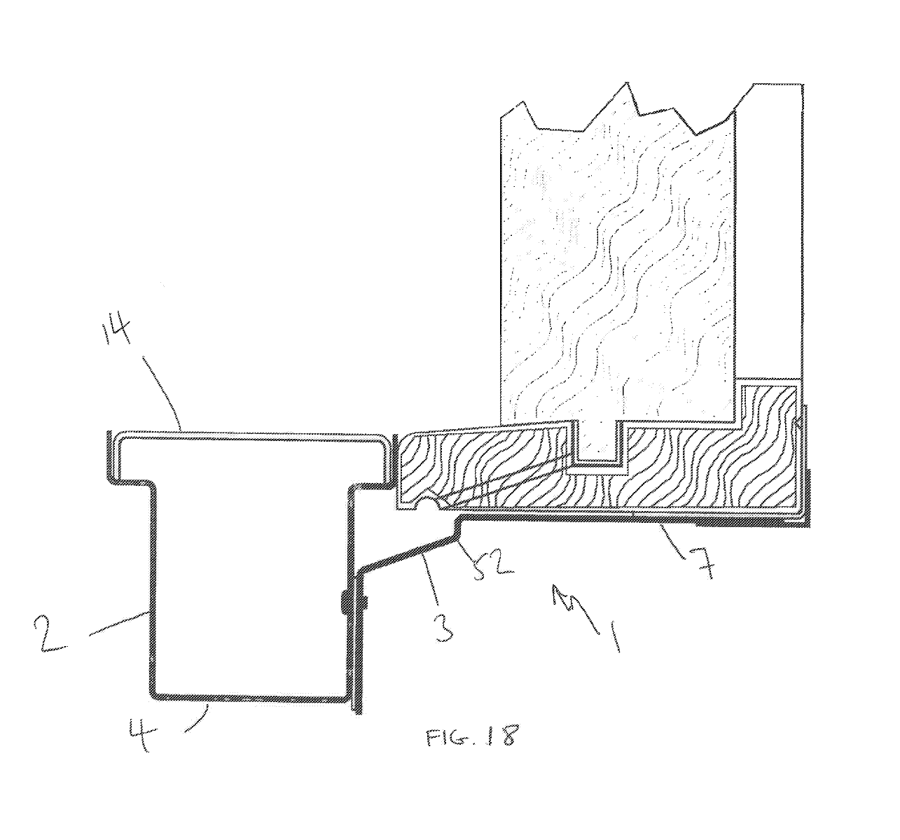

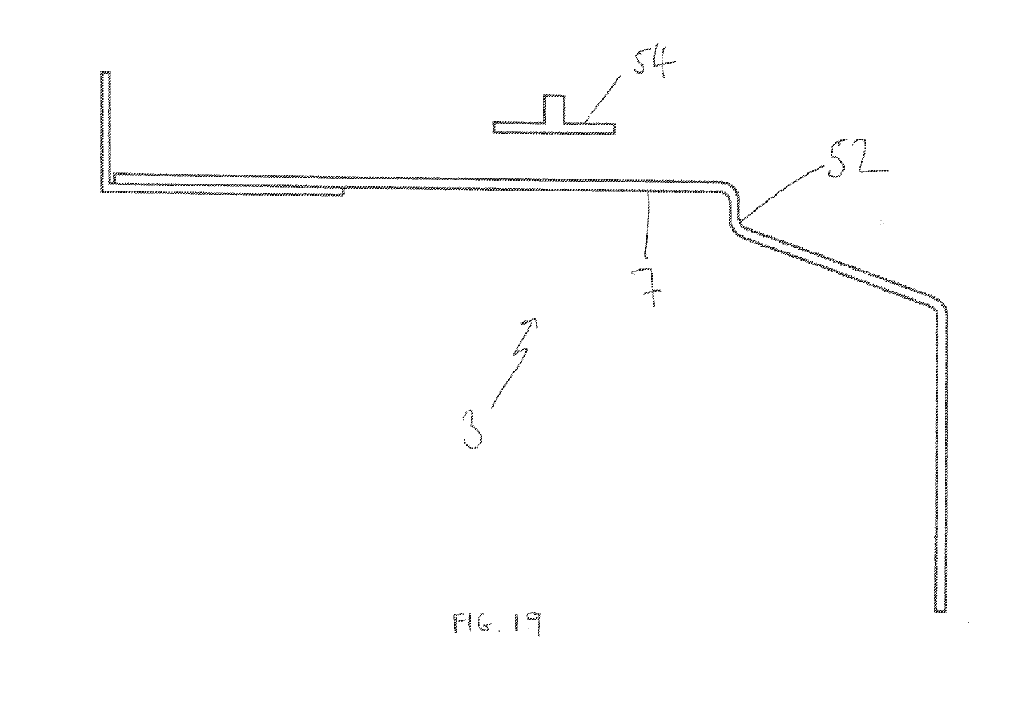

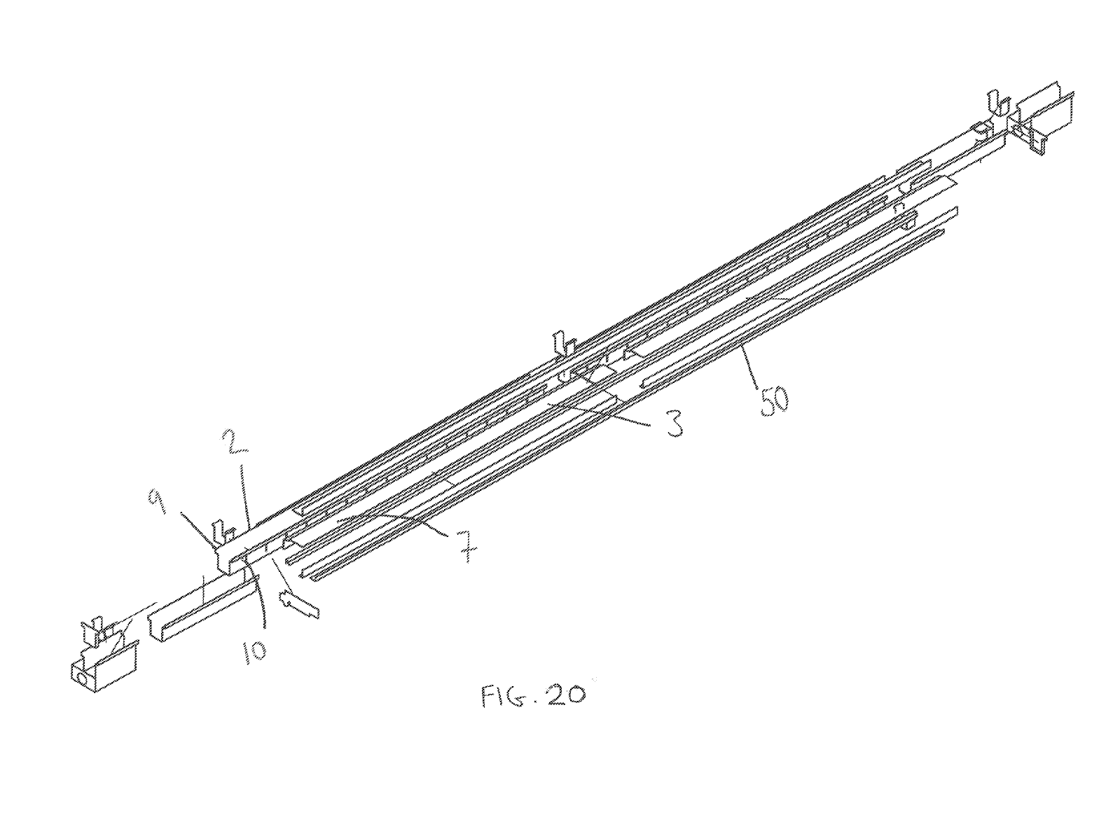

In a preferred embodiment, the first trough 2 is vertically adjustable so that if a sub-floor level rail or frame of a door is particularly deep or shallow (FIGS. 15 and 17), the first trough 2 can be adjusted so that the unit accommodates the rail/frame and the first trough 2 is positioned appropriately at ground level for collection of water.

This configuration allows the unit to be fully adjustable in vertical and lateral directions and allows for a large number of door threshold types to be accommodated including but not exclusively: sliding, bi-fold, lift and slide doors, swing type doors, curtain walling or fixed glass panels for ground floor, paved patio areas, suspended balconies and basement well areas. This configuration also allows the system to be utilised indoors as well as outdoors, for example, at the point of entry into wet areas such as showers, swimming pools, or located at lift wells.

This configuration also allows the drainage unit to be employed as a land drain by adjusting the unit as explained.

The drainage unit is compatible with standard drain connections such as 110 mm diameter plastic and clay pipes and DPC and cavity tray DPM installation levels thereby allowing drained fluid to be drained into main drainage systems. In alternative embodiments, the drain unit comprises sections such as corner angle sections, a silt and sieve boxes, universal spigots and butt joint connectors.

In a further preferred embodiment, the unit incorporates a fastener 51 for securing the first trough to the wall 7. This ensures that there is a watertight connection between the first 2 and second 3 troughs to ensure that effective drainage occurs away from a door.

In a further preferred embodiment the fastener is a riv nut or screw/bolt fixed into a vertical slot, retained by a captive fastener fitted to the wall. The vertical slot allows the unit to be adjusted in the vertical direction to accommodate rails/frames of varying configuration. However, it is envisaged that the fastener 51 could comprise any known fastening means. In an alternative embodiment, the fastener 51 consists of a tee section water bar, which is bonded to the first and second troughs to prevent water from leaking from the drainage unit. In this embodiment, a silicone infill can be used around the water bar for additional security.

In an even further preferred embodiment, the wall 7 incorporates a stepped portion 52 that prevents fluid from re-entering the sub-floor level rail or frame of a door, and minimises flooding out of the unit.

In an alternative embodiment, the unit incorporates an infill 53 which is employed when a gap is present between the first trough and the sub-floor level rail or frame of a door. The infill 53 provides strength to the drainage unit and prevents damage to the other components of the unit and the door rail/frame. The infill allows the unit to accommodate varying dimensions and depths of sub-floor level rails or frames of doors, whilst ensuring drainage of fluid away from the door is effective. The infill 53 also allows the first drainage trough 2 to be located at a distance from the doorway which offers aesthetic and/or structural advantages (i.e. improves the drainage of fluid into the first trough 2 from via the drain cover 14). In a preferred embodiment the infill consists of embossed stainless steel with a powder coated finish.

In a one embodiment, the unit consists of plastics such as polypropylene or Nylon66. Alternatively the unit consists of GRP or galvanised metal polyconcrete. Further materials, such as ethylene propylene diene monomer rubber (EPDM) or DPC may also be used to form at least part of the unit. However, it is envisaged that the unit can be manufactured using appropriate known alternatives. The cover can be manufactured from, but not exclusively, folded galvanised steel, stainless steel, extruded fold or pressed aluminium, stone composite or cast iron.

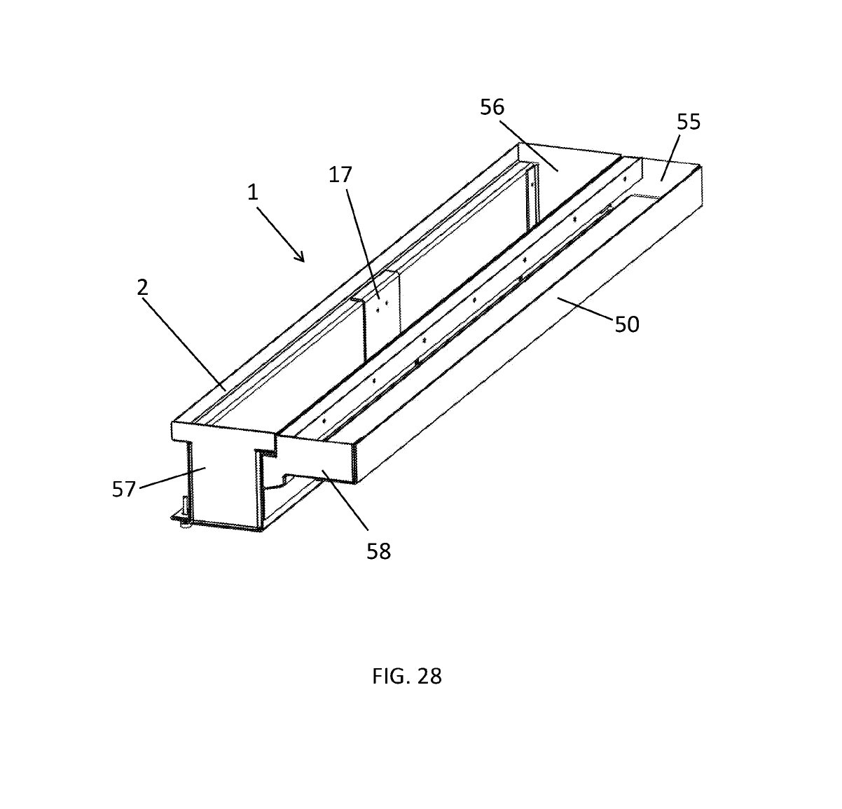

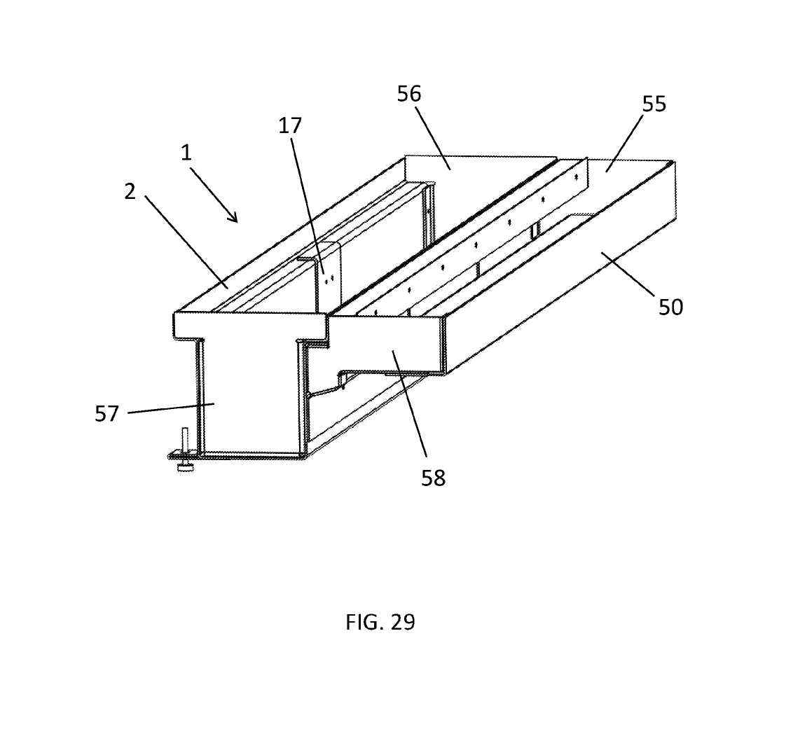

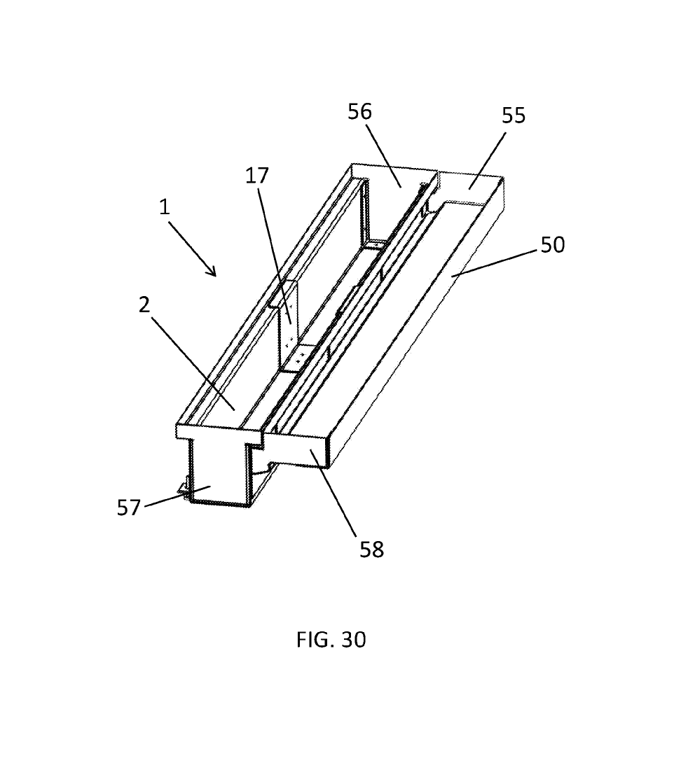

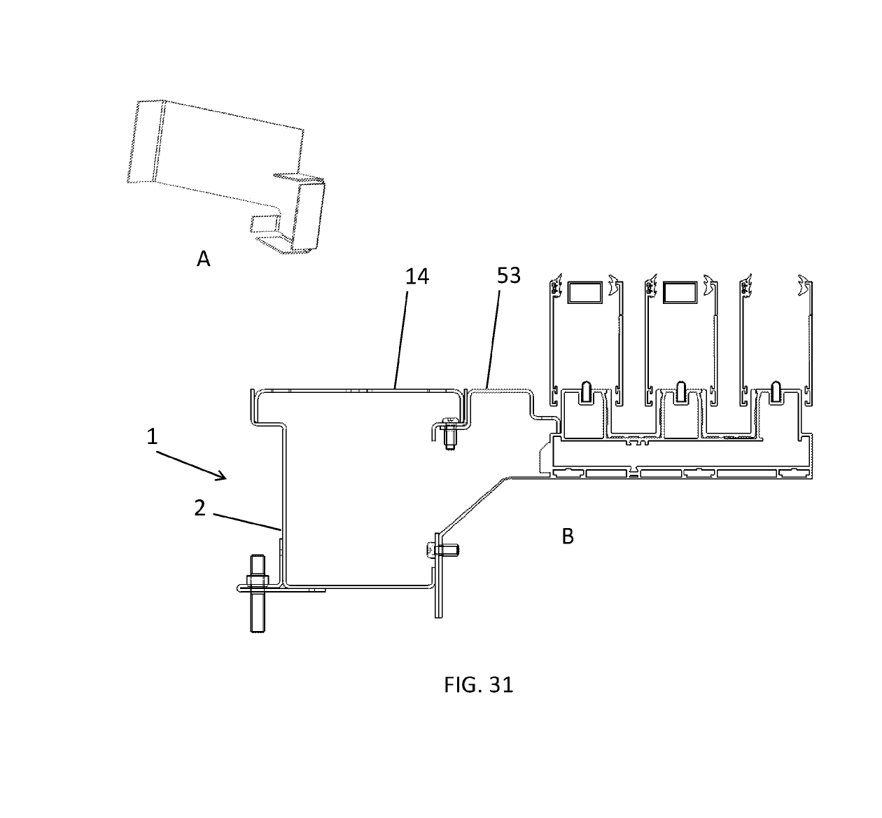

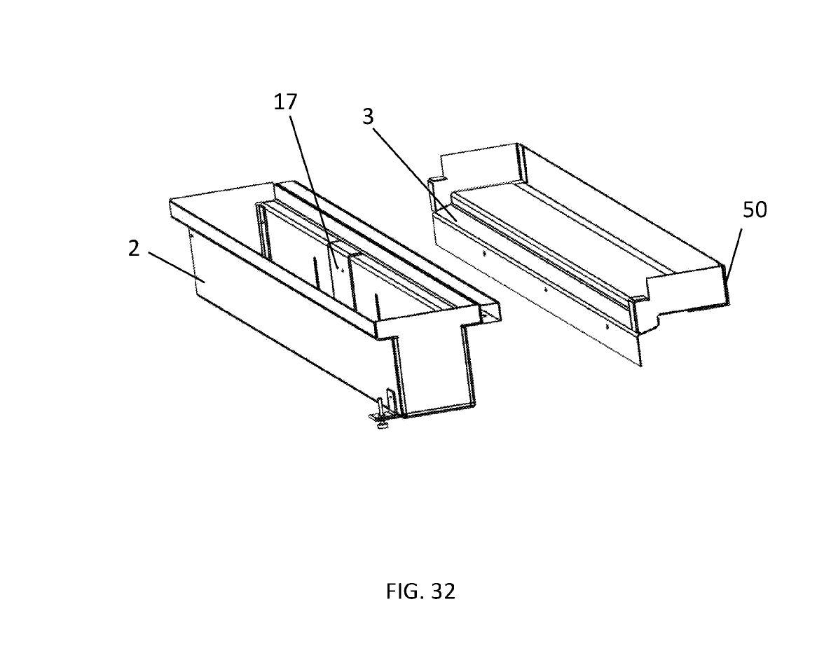

FIGS. 28 to 32 show perspective views of several alternative embodiments of the invention. These figures show the drainage unit wherein the unit 1 is employed such that the second drainage trough 3 extends directly beneath a sub-ground level rail or frame of a doorway and the first drainage trough 2 is located immediately adjacent the second drainage trough 3. FIG. 32 shows the first drainage trough 2 and second drainage trough 3 being spaced apart from one another.

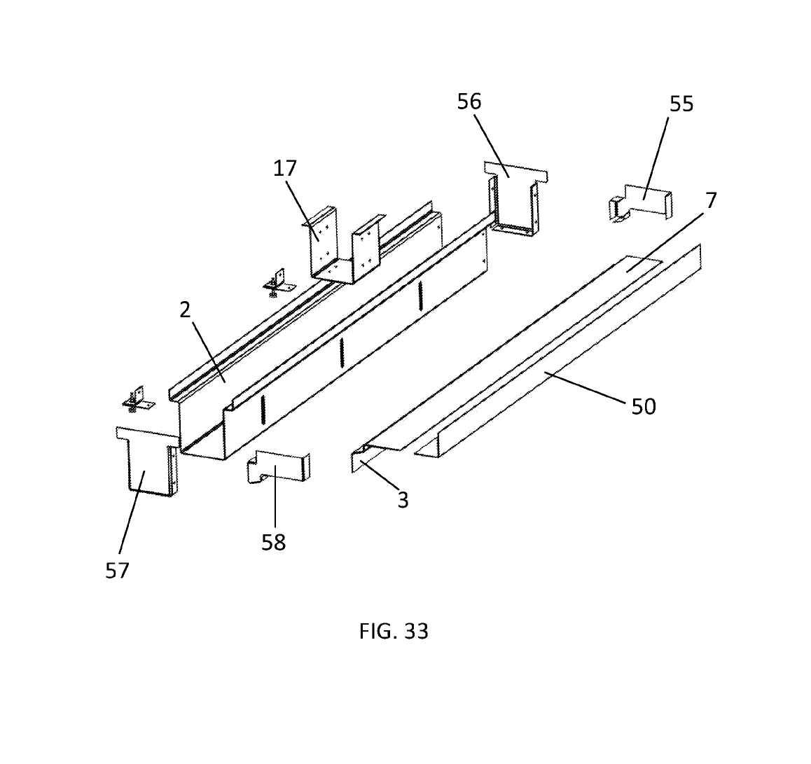

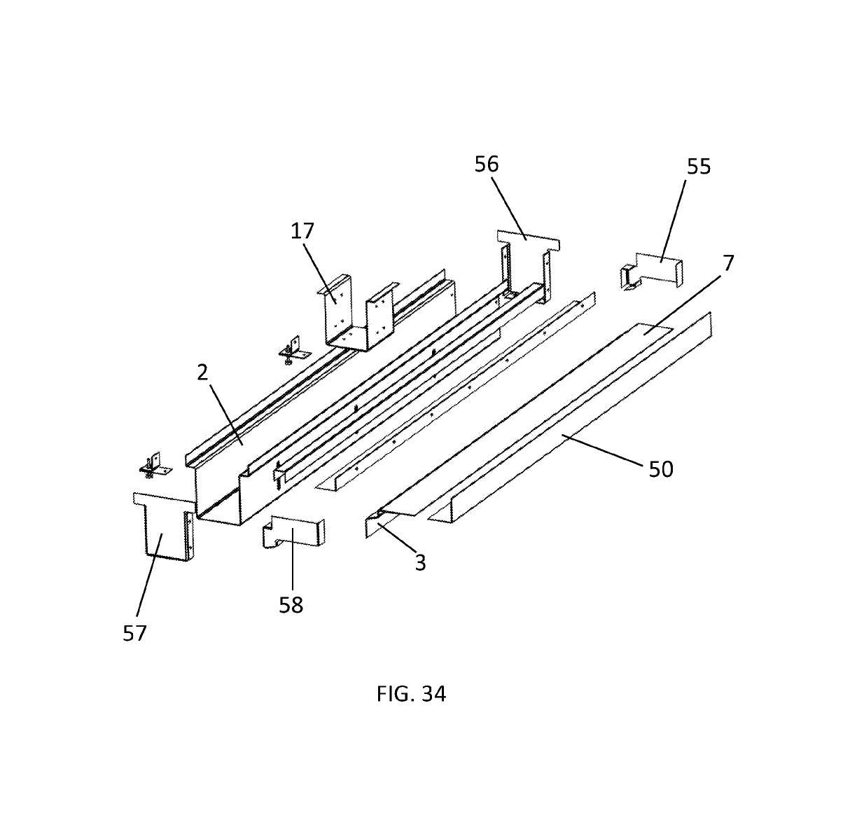

FIG. 33 shows an exploded perspective view of an alternative embodiment of the invention, showing the first drainage trough 2, the laterally projecting bottom wall 7 of the second drainage trough 3 and an L-shaped bracket 50. Stop ends 55, 56, 57 and 58, which are fixed to the ends of the first 2 and second 3 drainage troughs, prevent fluid from draining from the sides of the drainage unit 1 (unless a stop end with a tap is fixed). Joining member 17 acts to join two drainage units together.

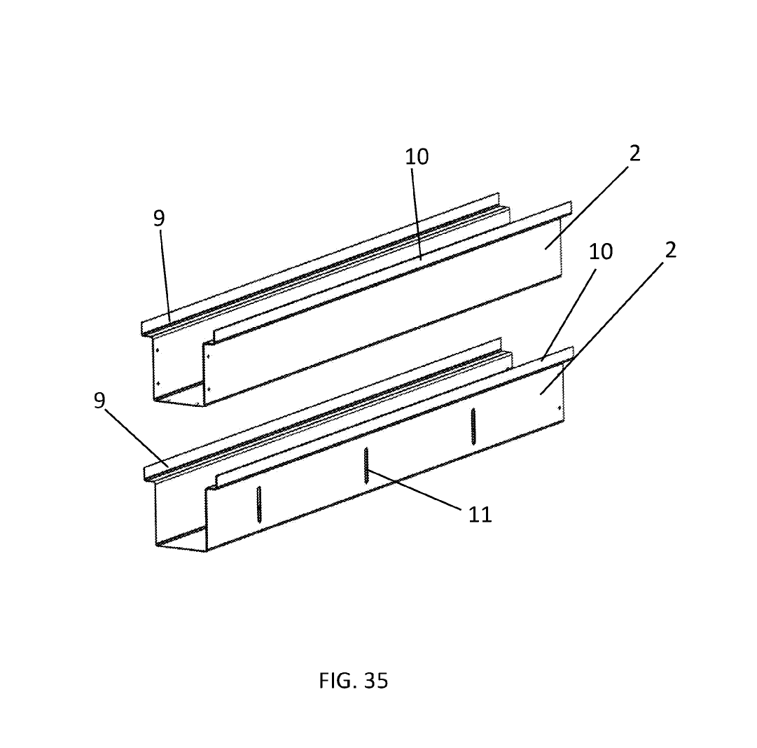

FIG. 35 shows two alternative embodiments of the first drainage trough 2, one where the first drainage trough 2 has a slotted side wall 6 and one where the first drainage trough 2 is not slotted.

In an alternative embodiment, the configuration of the first 2 and/or second 3 drainage troughs can be modified depending on the shape and/or size of the doorway.

The invention provides contained unit between the sub-ground level rail or frame of a doorway and the drainage unit, thus isolating the doorway structure from water penetration.

1. A drainage unit comprising a first drainage trough and a second drainage trough; said second drainage trough being located adjacent to said first drainage trough; said first drainage trough being configured to attach to a drain cover in order to allow fluid to flow into the first drainage trough; said second drainage trough comprising at least a wall which projects laterally from said first drainage trough; said wall being suitable for accommodating a sub-floor level rail or frame of a door; a number of openings located between said first and second drainage troughs; whereby fluid flows from said second drainage trough into said first drainage trough through said openings.

2. A drainage unit according to claim 1, wherein the wall's configuration is adjustable dependent on the configuration of the sub-floor level rail or frame of a door which said drainage unit accommodates.

3. A drainage unit according to claim 2, wherein said second drainage trough comprises a bottom surface; and at least a portion of said bottom surface of said second drainage trough closest to said first drainage trough slopes downwards towards said openings.

4. A drainage unit according to claim 1, wherein the first drainage trough incorporates a bottom wall and two side walls; and said second drainage trough incorporates a bottom wall; said bottom wall of said first drainage trough being located lower than the bottom wall of said second drainage trough.

5. A drainage unit according to claim 4, wherein the top of each side wall of said first drainage trough incorporates an L-shaped ledge.

6. A drainage unit according to claim 1, wherein said first drainage trough and said second drainage trough are integrally formed.

7. A drainage unit according to claim 1, comprising a sub-floor level rail or frame of a door being attached to said second drainage trough.

8. A drainage unit according to claim 7, wherein said second drainage trough comprises a bottom wall and a side wall; and wherein said drainage unit further comprises a fastener for securing a sub-floor level rail or frame of a door to said bottom wall or said side wall of said second drainage trough.

9. A drainage unit according to claim 1, comprising a clipping mechanism between said bottom wall of said second drainage trough and said sub-floor level rail or frame.

10. A drainage unit according to claim 1, wherein said second drainage trough incorporates a clip for securing the second drainage trough to a face of a door threshold.

11. A drainage unit according to claim 1, wherein said first and second drainage troughs are substantially U-shaped.

12. A drainage unit according to claim 4, wherein each side wall of said first drainage trough incorporates a number of apertures at each extremity.

13. A drainage unit according to claim 12, wherein said unit incorporates a joining member which is fixable between said apertures of two adjacent drainage units.

14. A drainage unit according to claim 13, wherein said joining member is substantially U-shaped and sized and shaped to fit within said first drainage trough.

15. A drainage unit according to claim 1, wherein the underside of both adjacent troughs is covered with a waterproof membrane.

16. A drainage unit according to claim 1, wherein said first drainage trough is vertically adjustable in relation to said second drainage trough.

17. A drainage unit according to claim 1, wherein said at least a wall of said second drainage trough is laterally extendible.

18. A drainage unit according to claim 1, wherein said unit incorporates a fastener for securing said first drainage trough to said at least a wall of said second drainage trough.

19. A drainage unit according to claim 1, wherein said at least a wall said second drainage trough incorporates a stepped portion.

20. A drainage unit according to claim 1, wherein said unit incorporates an infill positioned between said first drainage trough and said sub-floor level rail or frame of a door which said unit accommodates.

21.-23. (canceled)
